(19) United States
(12) Patent Application Publication
(10) Pub. No.: US 2020/0153037 A1
(43) Pub. Date: May 14, 2020

(54) MICROSCOPICALLY ORDERED SOLID ELECTROLYTE ARCHITECTURE MANUFACTURING METHODS AND PROCESSES THEREOF FOR USE IN SOLID-STATE AND HYBRID LITHIUM ION BATTERIES

(71) Applicant: FISKER INC., Los Angeles, CA (US)

(72) Inventors: Lawrence A. Renna, Huntington Beach, CA (US); Sam Keene, Long Beach, CA (US); Sean L. Barrett, Bigfork, MT (US); Daniel E. Overstreet, Flower Mount, TX (US); Vincent L. Giordani, Signal Hill, CA (US); John Chmiola, Scranton, PA (US); Sarah M. Miller, Torrance, CA (US); Martin Welch, Hermosa Beach, CA (US); Fabio Albano, Playa Vista, CA (US); Geeta Gupta, West Hollywood, CA (US)

(21) Appl. No.: 16/549,593

(22) Filed: Aug. 23, 2019

Related U.S. Application Data
(63) Continuation-in-part of application No. PCT/US2017/060546, filed on Nov. 8, 2018.

(51) Int. Cl. H01M 10/0562; H01M 10/0525

(52) U.S. Cl. CPC H01M 10/0562; H01M 2300/0071; H01M 10/0525

(57) ABSTRACT

Microscopically ordered solid electrolyte architectures for solid-state and hybrid Li ion batteries are disclosed. The architecture comprises at least one porous scaffold comprising a lithium conducting ceramic that is porous enough to be infiltrated with cathode or anode active material in an amount sufficient to enable energy densities greater than 300 Wh/kg. Methods of making these microscopically ordered solid electrolyte architecture by fabricating at least one green ceramic scaffold and applying at least one heat treatment step are also disclosed.

### RELATED APPLICATIONS

This application claims the benefit of priority to International application No. PCT/US2017/060546 filed on Nov. 8, 2018, U.S. provisional patent application No. 62/419,423 filed on Nov. 8, 2016, U.S. provisional patent application No. 62/722,260 filed on Aug. 24, 2018, U.S. provisional patent application No. 62/722,374 filed on Aug. 24, 2018, U.S. provisional patent application No. 62/722,381 filed on Aug. 24, 2018, U.S. provisional patent application No. 62/722,546 filed on Aug. 24, 2018, and U.S. provisional patent application No. 62/722,566 filed on Aug. 24, 2018, all of which are incorporated by reference herein.

### FIELD OF THE INVENTION

The present disclosure relates to the manufacturing methods and processes thereof of microscopically ordered solid electrolyte architecture for use in solid-state and hybrid lithium-ion batteries.

### BACKGROUND

Lithium ion batteries (LIBs) are the most advanced energy storage technologies to-date. In most applications of LIBs, such as electric vehicles and electronic devices, there is a specific form factor and weight limit into which the array of LIBs that power the device must fit. Thus, the volumetric (kWh/L) and gravimetric (kWh/kg) energy density of a LIB determines the total battery life of the ultimate application. For electric vehicles, this battery life corresponds to the range of the vehicle. Gasoline tanks can store the energy to drive the vehicle 300-500 miles before refilling, and refilling takes only 5-10 minutes; however, current generation batteries only offer capacities of 50-240 miles in affordable vehicles up to a maximum of 335 miles of high-end vehicles. Additionally, charging a LIB at rates that allow charge times comparable to gasoline refill times puts tremendous physical and chemical stress on the battery components, which can lead to capacity loss and even short circuit over the life of the battery. There is, therefore, a need for LIB electrodes that have 1) high capacity, 2) structural and chemical stability, 3) high electronic and ionic conductivity, allowing for effective and fast charging, and 4) structures that prevent short circuit and are safe.

LIB electrodes must fulfill numerous interrelated criteria to satisfy the above requirements. The electron-transporting active material(s) must have high electronic conductivity, high voltage against Li (for cathodes), and high Li ion cycling capacity. The ion-transporting electrolyte(s) in contact with the active material must have rapid charge transfer kinetics when undergoing the desired Li ion transfer reactions, chemical stability, high ionic conductivity, high electronic resistivity, and continuous contact with the active material. The separator between the anode and cathode must be thin, impenetrable to dendrites, have high ionic conductivity, high electronic resistivity, and have low interfacial resistances with the electrolyte(s) in the electrodes. Current LIB cathodes have limited energy density due to their small, ˜70 μm thickness, which is limited by the tendency of thicker cathodes to delaminate from the current collector during cycling. In order for thicker cathodes to be used, the cathode active material must be placed within a structurally robust porous scaffold that is non-tortuous. The effect of tortuosity on battery performance is illustrated in FIG. 6, highlighting the need for a non-tortuous structure. A geometric electrode structure that is simultaneously microscopically ordered, non-tortuous, and continuously connected to the separator is required to meet these criteria. The use of a solid-state ion conductor is imperative to fulfill the requirements of the separator, and to form a microscopically ordered scaffold in the electrode. There currently do not exist methods of manufacturing microscopically ordered architectures that utilize solid state electrolytes and are suitable for the use in LIBs.

The microscopically ordered solid electrolyte architectures for use in solid-state and hybrid lithium-ion batteries and methods of making as disclosed herein are directed to overcoming one or more of the problems set forth above and/or other problems of the prior art.

### SUMMARY OF THE DISCLOSURE

Disclosed herein are microscopically ordered solid electrolyte architectures for solid-state and hybrid Li ion batteries, wherein the architecture comprises at least one porous scaffold comprising a lithium conducting ceramic that is porous enough to be infiltrated with cathode or anode active material in an amount sufficient to enable energy densities greater than 300 Wh/kg. In an embodiment, the porous scaffold is a cubic garnet-type structure, such as Li₇La₃Zr₂O₁₂.

Also disclosed are methods of making a microscopically ordered solid electrolyte architecture for solid-state and hybrid Li ion batteries, the method comprising: fabricating at least one green ceramic scaffold capable of being infiltrated with cathode or anode active material in an amount sufficient to enable the finished electrode to reach energy densities of the greater than 300 Wh/kg, and performing at least one thermal treatment step.

### BRIEF DESCRIPTION OF THE DRAWINGS

An embodiment will now be described, by way of example only, with reference to the accompanying drawings, wherein:

FIG. 1 is a graphic providing a comparison of various properties and features of c-LLZO as employed in the present disclosure, versus common ionic conductors including LiPON and Li₁₀GeP₂S₁₂ (“LGPS”);

FIG. 2A shows a graph demonstrating the high ionic conductivity of two doped solid-state electrolyte samples prepared by casting and sintering at 1000° C. a c-LLZO nanoparticle slurry, according to the present disclosure, having a D50 average nanoparticle size of 400 nanometers (nm);

FIG. 2B shows a charge-discharge curve of a solid state battery cell according to the present disclosure by infiltrating a nickel-manganese-cobalt (NMC) cathode material into an LLZO electrolyte scaffold and laminating a lithium metal anode onto it, the results demonstrate the high energy density potential of the system exceeding 170 mAh/g;

FIG. 3 is a Ragone plot of the performance of the current technology according to the present disclosure compared to existing and emerging battery technologies;

FIG. 4A is a chart showing methods for casting nanoparticle slurries into films according to the present disclosure;

FIG. 4B is a flow chart showing the basic steps in the manufacturing of a solid-state electrolyte film according to the present disclosure;

FIG. 4C is a diagram showing the further assisting of the sintering process using light as described herein;

FIG. 4D is a diagram showing the basic steps in converting a nanoparticle slurry to a free-standing sintered film using freeze casting to form the film according to the present disclosure freeze casting of electrodes and Li-conducting solid-state electrolytes;

FIG. 5 is a schematic representation of several viable routes according to the present disclosure that lead to the creation of a smooth electrode/electrolyte interface that reduces or eliminates contact resistance and promotes ionic conductivity;

FIG. 6 is a theoretical model of cell operating potential vs. capacity for scenarios where the composite cathode has high, moderate, and no tortuosity. Cell capacity is strongly dependent on tortuosity of the cathode, highlighting the importance of order in the ion-conducting scaffold of a composite electrode. A perfectly ordered scaffold contributes zero additional tortuosity to the composite cathode, while a highly disordered scaffold contributes substantial additional tortuosity, resulting in capacity losses of up to 40%.

FIG. 7 is an example of a solid-state/hybrid lithium ion cell possessing a microscopically ordered composite electrode.

FIGS. 8A and 8B are microscopically ordered solid-state electrolyte scaffold infiltrated with active material for a battery electrode in a (top) bilayer configuration (FIG. 8A), and (bottom) trilayer configuration (FIG. 8B).

FIG. 9A is a scanning electron microscope (SEM) micrograph of a green c-LLZO porous scaffold formed by freeze tape casting of a slurry. FIG. 9B is an SEM micrograph of a ceramic ion-conducting bilayer architecture, in which a porous c-LLZO scaffold with >75% porosity is connected to a dense c-LLZO separator with >95% density.

FIG. 10 is an SEM micrograph of a ceramic ion-conducting bilayer architecture, in which a porous c-LLZO scaffold with >75% porosity is connected to a dense c-LLZO separator with >95% density.

FIG. 11 is a depiction of an exemplary example of the freeze tape casting process in the fabrication of green microscopically ordered solid-state electrolyte scaffolds.

FIG. 12 is a top-view of optical micrographs of two green ceramic scaffolds prepared via freeze tape casting demonstrating aligned, low-tortuous pores with >75% porosity.

FIG. 13 is a photograph of a green ceramic scaffold fabricated using a process in which a net shape mold is filled with a ceramic slurry for casting, to define the form factor of ceramic component of controlled and uniform cross section and planar form.

FIG. 14 is a depiction of an example for net shape casting monolithic bilayers of solid state electrolyte possessing both a porous scaffold and a dense ceramic separator.

FIG. 15 is an example of a c-LLZO green ceramic scaffold fabricated via net shape casting (right) and the components used to fabricate such a scaffold.

FIG. 16 is a 3D drawing of an exemplary 3D printed negative for a silicone mold intended for net shape casting of a ceramic bilayer architecture.

FIG. 17 is a depiction of the process by which a microstructured green ceramic scaffold is fabricated using an extrusion process.

FIGS. 18A and 18B are of a photograph (left) and SEM micrograph (right), respectively, of a ceramic separator that is free of continuous pinholes, less than 50 μm thick as-cast, is fabricated by tape casting a water-based slurry of ceramic particles and is >95% dense and <25 μm when sintered.

FIG. 19 is photograph of a c-LLZO ceramic separator that is free of continuous pinholes (top) with a photograph of a ceramic separator containing pinholes (bottom) for comparison.

FIG. 20 is a depiction of the process where uniaxial pressing is used to increase the density of green ceramic separators. In this example, uniaxial pressing results in a 17% increase in the green density.

FIG. 21 is a flow diagram of the process to formulate an aqueous ceramic slurry to be used in the fabrication of both porous scaffold and dense separator solid-state electrolytes.

FIG. 22 is a determination of freezing and melting points of water-based ceramic slurries by differential scanning calorimetry (DSC).

FIG. 23 is a green ceramic separator cast using a hydrocarbon-based binder and an aromatic hydrocarbon solvent. The green thickness is 14 μm and is uniform and pinhole free.

FIGS. 24A and 24B are depictions of two green porous ceramic electrolyte scaffolds made via freeze tape casting using two different acrylic copolymer binders.

FIG. 25 is an X-ray diffraction (XRD) pattern of both the porous scaffold component and the dense separator component of a co-sintered LLZO bilayer.

FIG. 26 is a Thermo-Gravimetric Analysis/Mass Spectrometry (TGA-MS) analysis of a green ceramic component. This analysis reveals the binder burnout process and the carbonate decomposition process.

FIG. 27 is an SEM micrographs of ceramic ion-conducting bilayer architectures in which a porous c-LLZO scaffold with >75% porosity is connected to a dense c-LLZO separator with >95% density.

FIG. 28 is a depiction of an exemplary example of a stack used in the sintering of porous ceramic electrolyte scaffolds with dense ceramic separators in a bilayer architecture.

### DETAILED DESCRIPTION

### Definitions

As used herein, the term “microscopically ordered” is intended to mean a 3-dimensional structure with features of sizes from 1 μm to 1000 μm that are not completely randomly arranged in at least one spatial dimension. The criteria for non-randomness is that it is physically possible to measure, with any degree of noise, a correlation length along the direction of order.

As used herein, a “solid-state battery” is a battery that contains no liquid and thus uses only a solid material as an electrolyte.

As used herein, a “hybrid battery” contains both solid and liquid electrolyte.

As used herein, the term “electrolyte” is intended to mean a liquid or gel that contains ions and can be decomposed by electrolysis, e.g., that present in a battery.

As used herein, the term “solid electrolyte” is intended to mean a solid material (as opposed to a liquid or gel) that contains ions and can be decomposed by electrolysis. A solid-state battery typically encompasses battery technology that uses solid electrodes and a solid electrolyte, instead of the liquid or polymer gel electrolytes.

As used herein, the term “c-LLZO” is intended to mean the cubic garnet-type structure Li₇La₃Zr₂O₁₂.

As used herein, the term “continuous pinholes” is intended to mean holes in a flat structure that penetrate all the way through the structure's thinnest dimension, such that the structure is permeable.

Disclosed herein are manufacturing methods and processes thereof for the fabrication of microscopically ordered solid electrolyte architectures, compatible for use in solid-state and hybrid lithium ion batteries, as depicted in FIG. 7. As is known in the art, a solid-state battery is a battery that contains no liquid and thus uses only a solid material as an electrolyte, while a hybrid battery contains both solid and liquid electrolyte.

In one form, the solid-state electrolyte is cubic-Li₇La₃Zr₂O₁₂ (“c-LLZO”).

Per another feature, the solid-state electrolyte may be a metal substituted c-LLZO with a general formula of Li₇La^{(3-x)}MₓZr₂O₁₂, where M is selected from the group but not limited to Al, Ga, Ta, W, and wherein “x” is a real-number from 0 to 3.

In an additional form, the solid-state electrolyte may be a metal substituted c-LLZO with a general formula of Li₇La₃Zr₍₂₋ₓ₎MₓO₁₂, wherein the metal M is selected from the group but not limited to Sc, Y, Ti, and another transition metal and wherein x has a value of from 0 to 2.

The solid-state electrolyte architecture according to the present disclosure can be formed by one or more of the methods selected from casting, freeze casting, freeze tape casting, sublimation, and sintering of slurries that are based on nanoparticles of the ceramic superfast ionic conductor electrolytes described herein and having conductivities (a) comparable to liquid electrolytes at working temperatures, i.e., 10⁻⁶<σ<10⁻¹ S·cm⁻¹, and activation energies that are <0.6 eV.

Nanoparticles that can be used for forming the solid-state electrolytes of the present disclosure can be fabricated by any of a variety of methods including, without limitation, sol-gel synthesis, plasma spray, ultrasonic assist spray synthesis, fluidized bed reaction, atomic layer deposition (ALD) assisted synthesis, chemical vapor deposition (CVD), physical vapor deposition (PVD), gas phase decomposition, detonation, flame spray pyrolysis, co-precipitation. However, it is preferred to start with nanoparticles having a spherical aspect ratio and bell-shaped size distributions that improve the packing density of the “green” films and allow lower sintering temperatures with final electrolyte film densities above 95%.

Suitable solvents for the nanoparticle-based slurries can be selected from, but not limited to, water, methanol, ethanol, propanol, butanol, xylene, hexane, methyl ethyl ketone, acetone, toluene, camphene, tert-butylalcohol, acetic acid, benzoic acid, camphene, cyclohexane, dioxane, dimethylsulfoxide, dimethylformamide, ethylene glycol, ionic liquids, glycerine ether, hydrogen peroxide, naphthalene, or a combination thereof. Preferably the solvent used is water as it is inexpensive, works well, can be rapidly frozen and sublimated via freeze casting to produce films having the desired porosity and density. The solvent is preferably used at a level of from 50 to 70% by weight of the slurry.

In some embodiments the nanoparticle-based slurries may optionally include a surfactant or dispersing agent to facilitate the nanoparticle suspension in the solvent. Examples of these surfactants and dispersing agents include, but are not limited to, sodium polynaphthalene sulfonate, sodium polymethacrylate, ammonium polymethacrylate, sodium polyacrylate, sodium lignosulfonate, polyethylene glycol p-(1,1,3,3-tetramethylbutyl)-phenyl ether, and Triton X-100 (C₁₄H₂₂O(C₂H₄O)ₙ).

In another embodiment, the precursor nanoparticle compounds have a general formula Li₇La₃Zr₂O₁₂ where “A” represents an eight-coordination cation and “B” represents a six-coordination cation, e.g. Li₇La₃Zr₂O₁₂ (garnet). Ionic conductivity of these materials could be further enhanced by substitution of “A” cations with Ta, Nb, Al, Ga, In or Te and substitution of “B” cations with Y, Ca, Ba, Sr.

According to another feature, the solid-state electrolyte is formed by casting nanoparticles of precursor materials made via spray pyrolysis of liquid precursors or by another suitable method, into a film followed by sintering the film wherein the sintering takes place at temperatures below approximately 1,100° C.

According to another feature a solid electrolyte scaffold, meaning a porous solid electrolyte structure, can be manufactured by freeze casting nanoparticle-based slurries of the precursor materials described herein. In some embodiments the dried freeze-cast scaffold may be followed by a sintering step at temperatures below 1,100° C.

In another embodiment the sintering step is further assisted by optical heating methods, e.g. laser, photonic, or flashing of suitable wavelength light. In another embodiment the sintering step is further assisted by IR irradiation or by an equivalent bulk heating method. Alternatively, the sintering is assisted by electrical or electromagnetic fields, wherein the sintering takes place within seconds of exposure and at temperatures below 1,000° C., preferably at temperatures between 90° C. and 700° C.

In one form, the solid-state electrolytes are made using scalable casting and sintering methods based on metal-oxide nanoparticle powders. More specifically, the solid-state electrolyte membranes (e.g. <30 μm thick) may be fabricated using nanoparticle powders that have sizes ranging from 20-900 nm synthesized by flame-spray pyrolysis, co-precipitation or other solid-state or wet chemistry nanoparticle (“NPs”) fabrication routes.

Nanoparticles that can be used for the disclosure can be synthesized by any of a variety of methods including, without limitation, plasma spray, ultrasonic assist spray synthesis, fluidized bed reaction, atomic layer deposition (ALD) assisted synthesis, direct laser writing (DLW), chemical vapor deposition (CVD), low pressure chemical vapor deposition (LPCVD), microwave plasma enhanced chemical vapor deposition (NPECVD), pulsed laser deposition (PLD), physical vapor deposition (PVD), gas phase decomposition, detonation, flame spray pyrolysis, co-precipitation, sol-gel synthesis, sol-gel dipping, spinning or sintering. As described they preferably have an average particle size of from 20 to 900 nm, such as from 200 to 600 nm.

The nanoparticles that can be used for preparing the solid-state electrolytes according to the present disclosure in certain embodiments can be coated, treated at the surface or throughout the bulk or in any open porosity by one or multiple layers of solid electrolyte materials or intermediate phases between solid electrolyte and anode or cathode active materials, e.g. a catholyte or anolyte suitable compound using one or more sequential deposition processes selected from, without limitation, plasma treatment, ultrasonic assist spray, fluidized bed reaction, atomic layer deposition (ALD), direct laser writing (DLW), chemical vapor deposition (CVD), low pressure chemical vapor deposition (LPCVD), microwave plasma enhanced chemical vapor deposition (NPECVD), pulsed laser deposition (PLD), physical vapor deposition (PVD), gas phase decomposition, detonation, flame spray pyrolysis, co-precipitation, sol-gel synthesis, sol-gel dipping, spinning or sintering, sputtering, radio frequency magnetron sputtering, nanoimprint, ion implantation, laser ablation, spray deposition.

It is preferred, but not strictly necessary, to start with nanoparticles having a spherical aspect ratio and bell-shaped size distributions that improve the packing density of the green films formed and result in lower sintering temperatures with final film densities above 95% for incorporation into a LIB design.

In another embodiment, the precursor compounds have a general formula Li₇A₃B₂O₁₂ where “A” represents an eight-coordination cation and “B” represents a six-coordination cation, e.g. Li₇La₃Zr₂O₁₂, a garnet type structure including a transition metal oxide. Ionic conductivity of these materials could be further enhanced by substitution of “A” cations with Ta, Nb, Al, Ga, In or Te and substitution of “B” cations with Y, Ca, Ba, Sr.

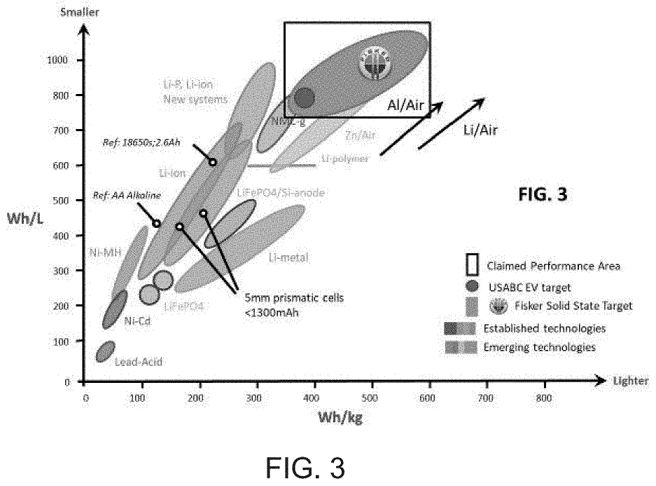

The solid electrolyte architectures produced using the approaches disclosed in the present disclosure will enable batteries with superior performance to any of the existing lithium ion or other battery chemistries. Additionally, they will have distinct performance from any of the emerging battery technologies as outlined in FIG. 3. In particular, the batteries enabled with the methods disclosed herein will have gravimetric energy density between 350 and 650 Wh/kg and will also have volumetric energy density between 750 and 1,200 Wh/L.

The nanoparticles used to form the slurries in the present disclosure may be conditioned using one of the three approaches shown in FIG. 5. For example, the nanoparticles may be coated using atomic layer deposition (ALD) or pulsed laser deposition (PLD) in a fluidized bed reactor to create a good electrode-electrolyte interface. One of the suitable material coatings applied via ALD or PLD may be lithium-phosphorous-oxynitride (LiPON) or another suitable solid-state electrolyte coating. In another embodiment, the nanoparticles may be made into nano-composite particles by ball milling as shown in FIG. 5. This process allows creating intermediate phases between the active materials and the electrolyte that are useful as catholyte or anolyte, and facilitates ionic diffusion within the anode or cathode films and that support subsequent manufacturing steps, e.g. the creation of a functional interface layer at the anode or cathode interfaces with the electrolyte films. Such interfaces are needed in particular to manage dendrites and lithium metal shorting generated from a lithium metal anode in contact with certain solid-state electrolytes, e.g. LLZO. Also as shown in FIG. 5 the nanoparticles can be conditioned by forming a matrix with liquid or amorphous material infiltration using for example various glass electrolytes.

According to another feature, the solid-state electrolyte is formed by casting into a film and then sintering of nanoparticles of precursor materials made via spray pyrolysis of liquid precursors, or another suitable method, wherein the sintering takes place at temperatures below approximately 1,100° C.

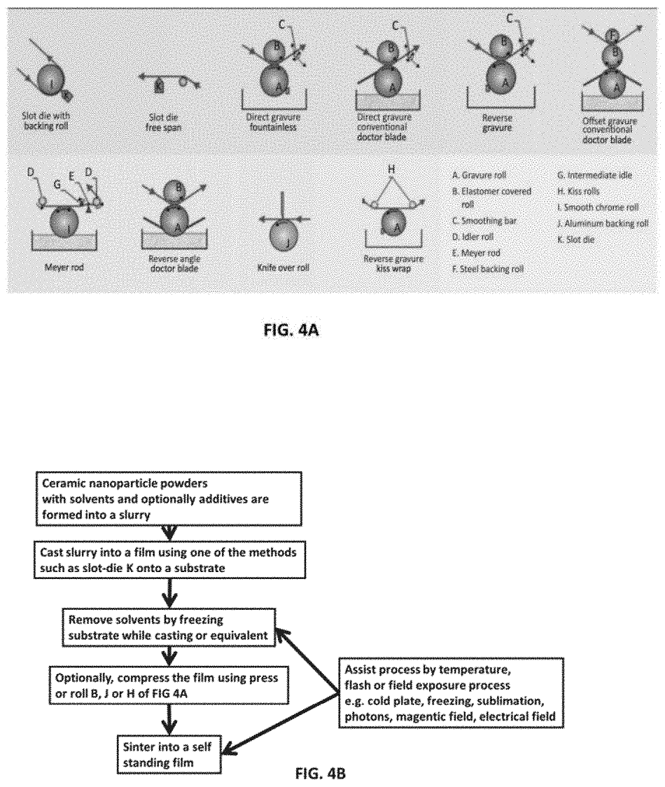

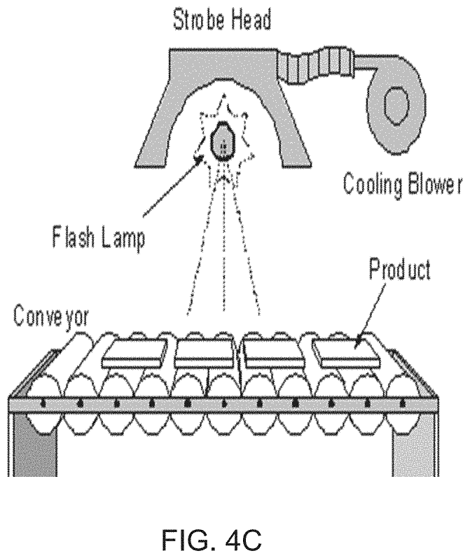

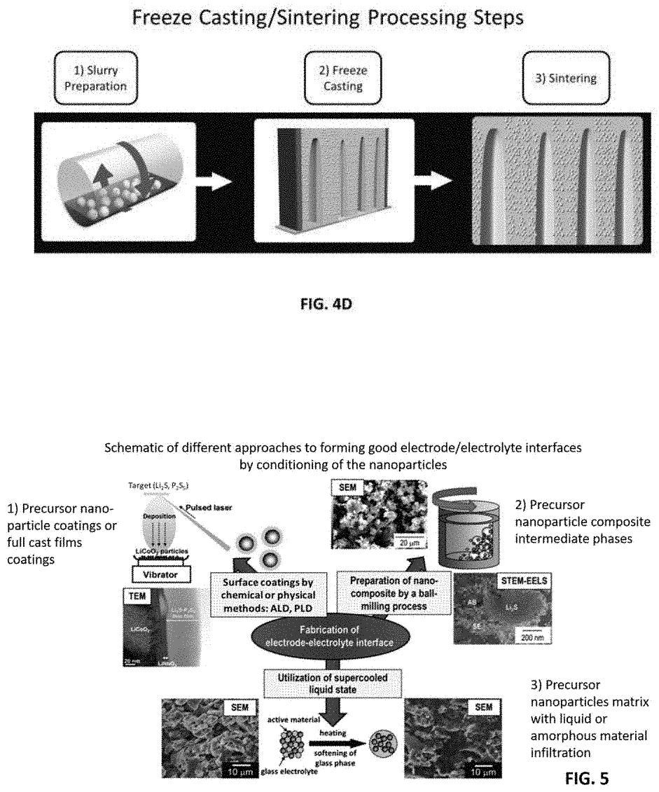

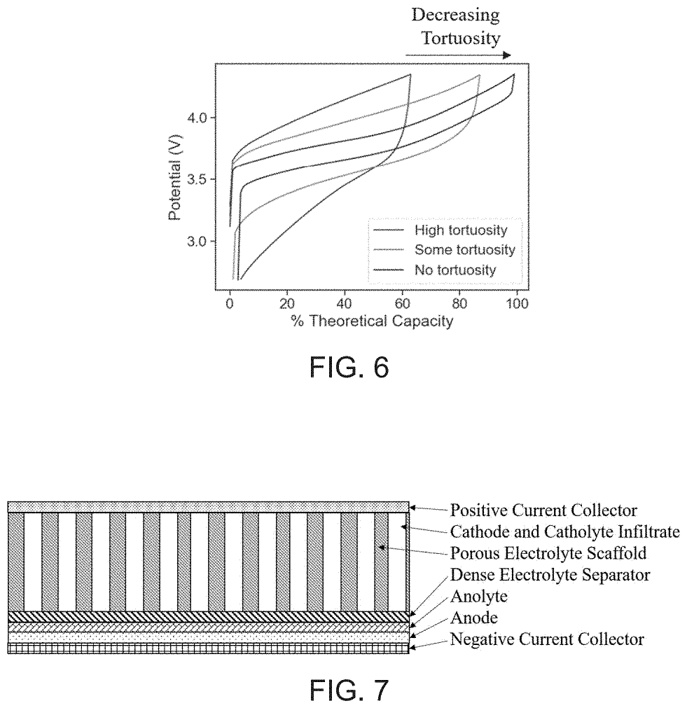

The basic process steps in the present disclosure are shown in FIG. 4B as further described in FIGS. 4A, 4C and 4D. In a first step the nanoparticle precursor materials are formed into a slurry using a suitable solvent and optional additives. Suitable solvents for the nanoparticle-based slurries can be selected from, water, methanol, ethanol, propanol, butanol, xylene, hexane, methyl ethyl ketone, acetone, toluene, water, camphene, tert-butyl alcohol, acetic acid, benzoic acid, camphene, cyclohexane, dioxane, dimethylsulfoxide, dimethylformamide, ethylene glycol, ionic liquids, glycerol ether, hydrogen peroxide, naphthalene, or a combination thereof. Preferably the solvent used is water as it is inexpensive, works well, can be rapidly frozen and sublimated via freeze casting to produce films having the desired porosity and density. The solvent is preferably used at a level of from 50 to 70% by weight of the slurry.

In some embodiments the nanoparticle-based slurries may optionally include a surfactant or dispersing agent to facilitate the nanoparticle suspension in the solvent. Examples of these surfactants and dispersing agents include, but are not limited to, sodium polynaphthalene sulfonate, sodium polymethacrylate, ammonium polymethacrylate, sodium polyacrylate, sodium lignosulfonate, polyethylene glycol p-(1,1,3,3-tetramethylbutyl)-phenyl ether, and Triton X-100 (C₁₄H₂₂O(C₂H₄O)ₙ).

The slurries are then cast into a film using one of the processes shown in FIG. 4A, preferably via freeze casting using a slot die with sublimation of the solvent. In freeze casting the casting bed is at a temperature at or below the freezing point of the solvent and the cast slurry freezes within 60 seconds or less followed by sublimation of the solvent. This preferably produces a solid electrolyte scaffolding film having a porosity of greater than 50%, fairly uniform pore sizes of 5 μm or larger wherein the pores are oriented in the same direction. Preferably this freeze casting is followed by sintering steps conducted under an extra dry atmosphere comprising air, O₂, or N₂ gases. Air is preferred due to cost considerations. The initial sintering takes place at a lower temperature of 500 to 700° C. for 1 to 4 hours. This is followed by sintering at higher temperatures of 1,100° C. or less for 1 to 8 hours with the temperature increased using a temperature ramp rate of 5 to 10° C. per minute under very low to no pressure.

In another embodiment the sintering is assisted by optical heating methods, e.g. laser, photonic, or flashing of suitable wavelength light. Alternatively, the sintering is assisted by electrical or electromagnetic fields, wherein the sintering takes place within seconds of exposure and at temperatures below 1,100° C., preferably at temperatures between 90° C. and 700° C., see for example FIGS. 4B and 4C.

The inventive architectures disclosed herein are made economical via manufacture using a low-pressure sintering method and the replacement of existing separator materials, liquid electrolytes, and temperature management peripherals. In FIG. 4A to FIG. 4D, the manufacturing steps that enable novel routes of synthesizing these layered materials in an industrial process with high throughput are shown. Once the nanoparticle slurry is made, any of the application methods shown in FIG. 4A to 4D can be used, e.g. freeze casting reported in FIG. 4D, to form films of the slurries and then the individual formed film layers can be sintered using a low pressure process at temperatures below 1,100° C. Alternatively, multiple layers can be sintered in one single pass through the sintering process after laying down multiple films. As shown in FIGS. 4A and 4B a variety of methods can be used to form the films from the nanoparticle slurries that are then sintered. Results with films prepared according to the present disclosure have shown in Scanning Electron Microscopy (SEM) images that the produced films have low surface asperity and are preferably very smooth, hence, as shown in FIG. 4B, an optional step can include a compression step to further remove any surface roughness and to reduce it to an average surface roughness parameter of less than 400 nm. In certain embodiments the sintering may be assisted with optical methods, e.g. a flash lamp or a laser; the sintering assist method increases the manufacturing throughput and facilitates the sintering process so it can take place at lower than theoretical temperatures, see FIG. 4C.

In another embodiment of the present disclosure the individual layers or the whole stack can be formed via casting, freeze casting or any other viable method that is capable of forming a thick film of the precursor nanoparticle material. After casting and solvent removal by drying or sublimation, the film may undergo a sintering step.

The present disclosure also comprehends several avenues to improve c-LLZO films to enable Li cycling without shorting, to generate solid ion conductors that can prevent dendrite growth, self-discharge, and to promote safety, power, and cycle life.

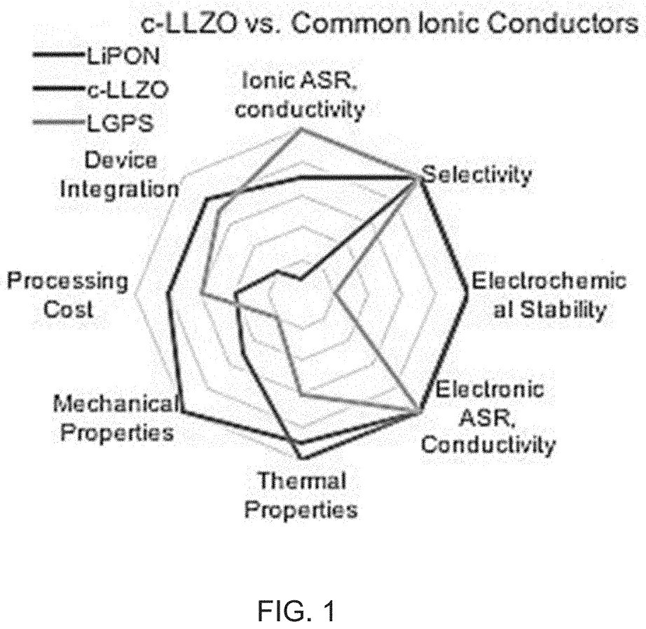

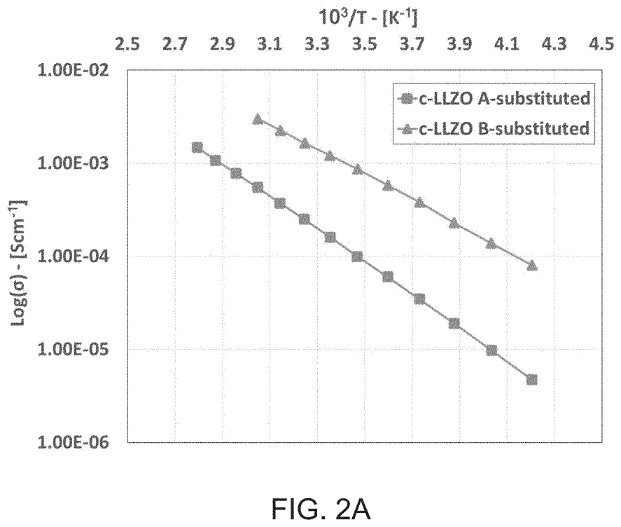

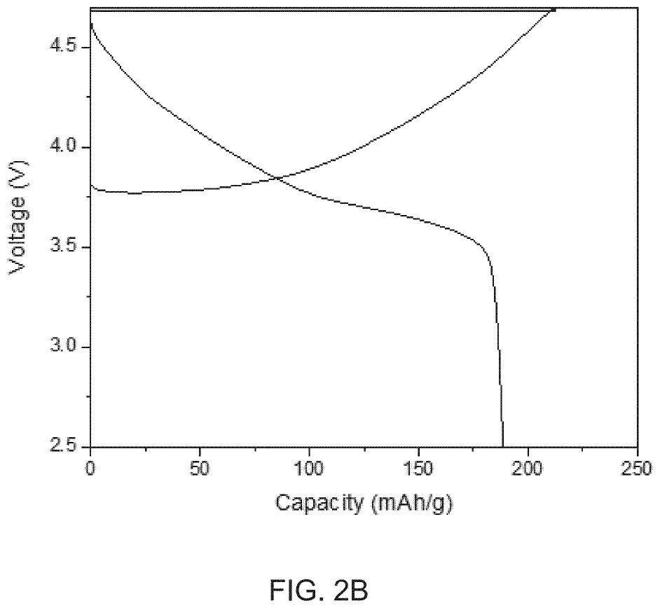

Solid-state ion conductors, e.g. newly developed c-LLZO combined with high energy density cathodes and Li anodes according to the present disclosure, represent innovations that remove the tradeoffs between energy and cycle life. Novel c-Li₇La₃Zr₂O₁₂ ion-conducting solid-state films made by freeze casting and low-pressure sintering of nanoparticles according to the present disclosure can overcome most of the existing technical gaps in solid-state electrolytes and can attain ionic conductivities comparable to liquid electrolytes, see FIGS. 1 and 2A. As shown in FIG. 2A freeze-cast films sintered according to the present disclosure show significant conductivity even at temperatures below 0° C. and even below −30° C. The A-substituted film was formed from Li₇La₃₋ₓMₓZr₂O₁₂ wherein M was aluminum; the B-substituted film was formed using gallium as the metal. These materials prepared according to the present disclosure are uniform, thin 30 μm), 95+% dense with Li+ conductivity comparable to traditional ICMs with liquid electrolytes. The slope of the curves is constant and linear, prior art systems demonstrate a hockey stick shaped curve wherein the conductivity at temperatures of 0° C. or lower are equal to nearly 0° C. In addition, other solid-state electrolyte materials, well-known in the field of thin-film batteries, are costly, produced through unscalable techniques and difficult to integrate in existing battery systems. FIG. 2B demonstrates the benefits of solid-state ionic conductors according to the present disclosure like the ones reported in FIG. 2A when integrated into a full solid-state battery cell system constructed using freeze casting methods outlined in the present disclosure.

Previously it has been demonstrated that c-LLZO and LiTi₂(PO₄)₃ Li+ conducting films by processing NPs can provide films <30 μm thick with ion conductivities ˜1 mS cm⁻¹. Details are described, for instance, in Eongyu Yi et al., “Flame made nanoparticles permit processing of dense, flexible, Li+ conducting ceramic electrolyte thin films of cubic-Li₇La₃Zr₂O₁₂ (c-LLZO),” J. Mater. Chem. A, 2016, 4, 12947-12954. These prior art films suffer from several deficiencies including: they have very little to no conductivity at temperatures of 0° C. or less; they require high sintering temperatures well above 1,110° C. and very long sintering times. All of these drawbacks make these films impractical for use in commercial batteries.

FIGS. 4A-4D show the processing steps needed to produce films according to the present disclosure. The use of nanoparticles within the desired size range described herein permits one to create dense solid-state films and to use low sintering temperatures of less than 1,100° C. and much shorter sintering times to produce the final films.

It has already been demonstrated in the literature how to produce thin LLZO films <30 μm thick and a few cm² in size. While this is a notable achievement, translating to thinner films <15 μm thick with larger area dimensions of >30 cm² raises more processing challenges. The present disclosure process has overcome these processing challenges by: utilizing precursor particles having a nanometer size with D50 particle size of 20 to 900 nm, preferably 200 to 600 nm and most preferably approximately 400 nm, while the prior art utilized particles having a size of greater than 1 micron; by assisting the casting process steps with other techniques including freeze casting, thermal aging, and sublimation of the slurry solvents; and by controlling electrode and electrolyte microstructure and porosity by using proper casting temperature and times/speed. As described herein preferably in one embodiment the porosity is greater than 50%, with uniform pores having a size of 5 μm or larger and uniform direction of the pores. The sensitivity of LLZO sintering to numerous parameters is notable and raises concerns in obtaining large area films with uniform microstructures and phase compositions. Even >90% uniformity may be insufficient. Open pores in the separator generated by partial over- or under-exposure during sintering will likely be avenues for Li dendrite propagation. Thus, temperature variations within the furnace require control of all processing conditions. Alternately, any defective areas, e.g. open pores, may be safely protected/blocked with a very thin solid-state amorphous electrolyte, e.g. LiPON, or polymer-based solid-state electrolyte overcoat as described herein.

In another embodiment the LLZO film can be cast on a flat bed and the solvent removed after freezing through a sublimation process then followed by a sintering step as shown in FIG. 4D according to the present disclosure.

The present disclosure lowers sintering temperatures to ≈1000° C. to expand the optimal processing window resulting in higher tolerance to temperature variations during sintering. Compounds in the Li₂O—P₂O₅—SiO₂—B₂O₃ (“LPSB”) system have been used widely as sintering aids for LLZO, showing moderate improvements in reducing the required energy input for densification when mixed with micron sized particles. For example, others have sintered Ta:LLZO-Li₃BO₃ (10 vol. %) composites to 90% density at 790° C. with ambient ionic conductivity of 0.36 mS cm⁻¹. Still others have processed Al:LLZO-Li₃BO₃ (13 vol. %) composites to 92% density by sintering at 900° C. with conductivities of 0.1 mS cm⁻¹ at 30° C. The drop in net ionic conductivity is not significant compared to neat LLZO, considering ˜10 vol. % addition of low ionic conductivity secondary phase and low relative densities. However, Li₃BO's low Tₘ of 700° C. prevents sintering composites at higher temperatures due to volatility, limiting accessible densities. According to our disclosed process the sintering temperatures are lower than in the past which reduces costs and the sintering times are much shorter. In addition, films produced according to the present disclosure are very dense, on the order of greater than 95%, making the films much stronger. Unlike the prior art the dense films according to the present disclosure do not require pressure to produce the dense films. Also as shown in FIG. 2A batteries produced according to the present disclosure have reasonable conductivity values even at −30° C. whereas the prior art had little to no conductivity at temperatures of 0° C. or less.

The film processing disclosed herein can theoretically result in non-uniform microstructural and phase compositional distributions, deteriorating overall battery performance. Hence, the present disclosure comprehends introducing solvents, described herein, that can be easily removed via freezing (sublimation) after or during the films coating operation and use of sintering aids to lower the sintering temperatures, widening the optimal sintering window to increase overall uniformity of sintered large area films thereby avoiding these theoretical issues.

Many different (electro)chemical approaches have been proposed to prevent dendrite formation. One suppression method involved adding saccharin or bubbling hydrogen to reduce formation of Ni or Zn dendrites. Magnetic fields have been used to manipulate dendrites morphology during electrodeposition of Cu, suppressing it to some degree. Such measures cannot work for commercial batteries. Other methods include additives to liquids, or gel electrolytes as possible routes to improve LIB stability/performance. Different solid electrolytes have been investigated in production, but these present problems of their own, eventually translating to alternative safety concerns and energy losses. Surface microstructural control and surface flattening have been shown to promote a homogeneous distribution of Li current as well as Li/LLZO contact, such that non-uniform dissolution/deposition of Li, i.e. dendrites, and interfacial resistance are reduced, resulting in higher critical current densities.

The present disclosure comprehends several avenues to either mechanically block Li dendrites or maximize distribution of the Li+ current by increasing Li/electrolyte interfacial areas to enhance tolerable current densities with a target performance >3 mA/cm² at ambient temperature.

Fabricating several tens cm² c-LLZO composite films <10 μm thick, with conductivities of 0.5-1 mS/cm using any of the manufacturing methods shown in FIGS. 4A to 4D.

Fabricating several tens cm² bilayer c-LLZO films <60 μm thick using any of the manufacturing methods shown in FIGS. 4A to 4D.

The methods wherein the film coating is performed by techniques including but not limited to bar coating, wire wound rod coating, drop casting, freeze tape casting, freeze casting, casting, spin casting, doctor blading, dip coating, spray coating, microgravure, screen printing, ink jet printing, 3D printing, slot die casting, reverse comma casting, acoustic sonocasting, acoustic field patterning, magnetic field patterning, electric field patterning, photolithography, etching, self-assembly, or combinations thereof.

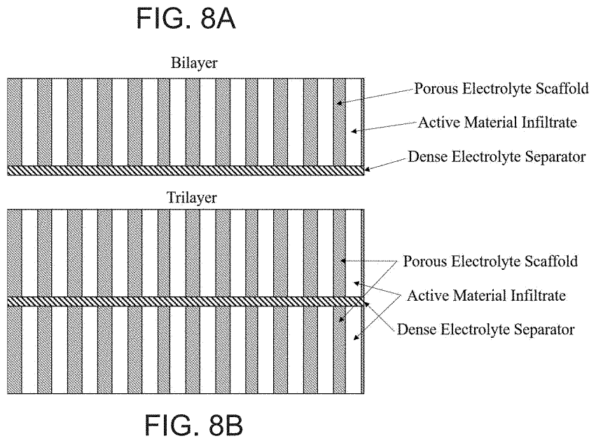

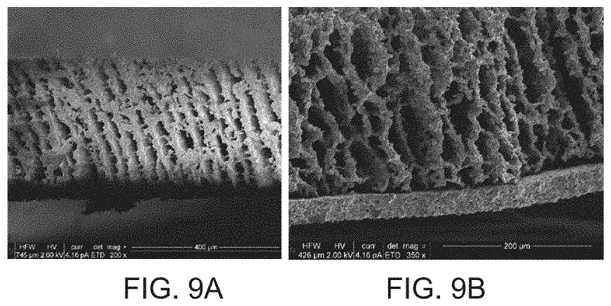

In one embodiment, a solid electrolyte architecture comprises a porous ceramic scaffold, with 75%-95% porosity, which is connected to dense solid-state ion-conducting separator in a bilayer architecture, with densities greater than 95%, as depicted schematically in FIG. 8A, a trilayer architecture (FIG. 8B) and shown in FIGS. 9A and 9B. More specifically, FIG. 9A is a scanning electron microscope (SEM) micrograph of a green c-LLZO porous scaffold formed by freeze tape casting of a slurry containing water as the primary solvent, a polymeric binder, a dispersant, a plasticizer, a secondary solid additive, and a viscosity modifier. FIG. 9B is an SEM micrograph of a ceramic ion-conducting bilayer architecture, in which a porous c-LLZO scaffold with >75% porosity is connected to a dense c-LLZO separator with >95% density. The porous layer is formed by freeze tape casting of a water-based slurry, the dense layer is formed by tape casting of a water-based slurry, and the two layers are continuously sintered together.

In another embodiment, a solid electrolyte architecture possesses two porous ceramic scaffolds, with 75%-95% porosity, and are connected to a single dense solid-state ion-conducting separator, with densities greater than 95%, in a trilayer architecture.

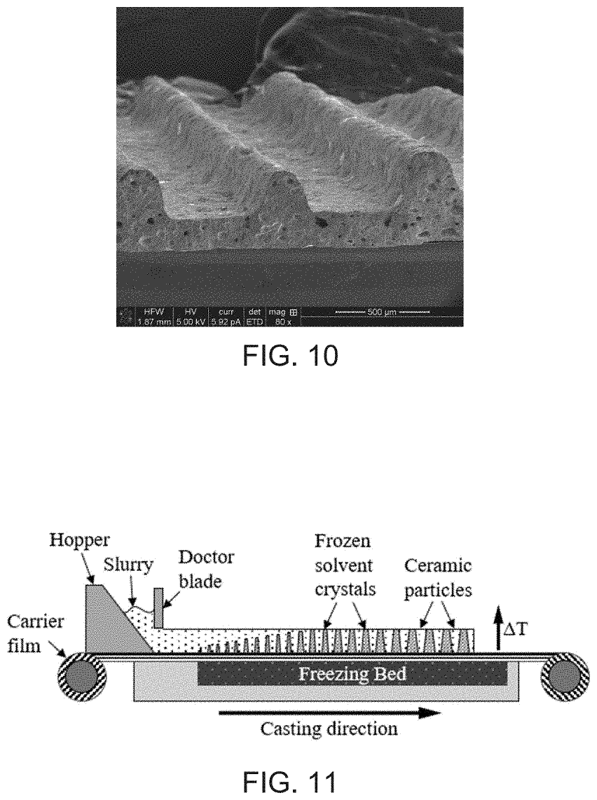

In another embodiment, the porous ceramic scaffold and the dense separator are monolithic and fabricated using net shape casting as shown in FIG. 10; in this embodiment, the net shape mold used in the fabrication of the component contains features that produce both the porous scaffold and the dense separator in a single component. FIG. 10 is an SEM micrograph of a ceramic ion-conducting bilayer architecture, in which a porous c-LLZO scaffold with >75% porosity is connected to a dense c-LLZO separator with >95% density. The architecture is formed by net shape casting from a silicone mold generated from a 3D printed negative. The silicone mold is filled with a slurry of ceramic particles, paraffin wax as the primary solvent, a long-chain carboxylic acid dispersant, a polyethylene binder, and a secondary solid material to create a green cast. The green cast is then sintered to form a continuous structure.

In one embodiment, a solid electrolyte architecture is composed of a microscopically ordered solid-state ion conducting ceramic fabricated by the method of freeze tape casting and sublimation. In this process, a hopper is filled with a ceramic slurry, then the carrier film is moved across the casting surface and the slurry is drawn through the doctor blade at a set gap height. The doctor blade-cast slurry is then moved over a freezing bed which induces a temperature gradient through the thickness of the cast slurry. In the freezing bed zone, the solvent begins to freeze and excludes the solids dispersed in the slurry. The frozen solvent is then removed via sublimation or freeze drying. The resulting structure is shown in FIG. 11, which is a depiction of an example of the freeze tape casting process in the fabrication of green microscopically ordered solid-state electrolyte scaffold.

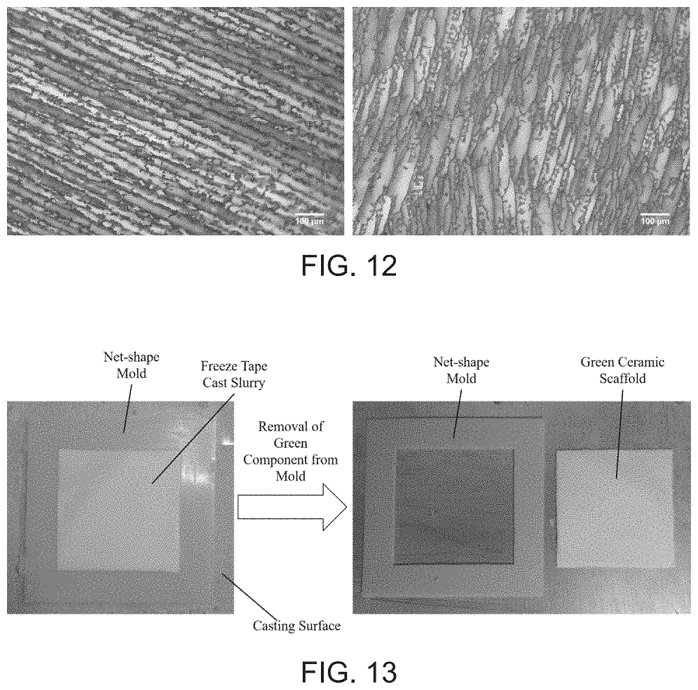

In another example, the pore sizes of the freeze-tape-cast scaffolds are 20 μm to 1000 μm, as shown in FIG. 12.

In one embodiment, a solid electrolyte architecture is composed of a microscopically ordered solid-state ion conducting ceramic fabricated by the method of tape casting and subsequent freeze casting and sublimation.

In one example, a solid electrolyte architecture is composed of a microscopically ordered solid-state ion conducting ceramic fabricated by adding a ceramic slurry to a net shape mold and freezing the slurry, allowing the form factor of the green ceramic component to be predefined precisely by the net shape mold, as shown in FIG. 13. As is known in the art, a “green” ceramic component is a ceramic component produced any structure-forming process (such as casting from a slurry) that has not been subject to additional processing steps such as sintering or removal of organics.

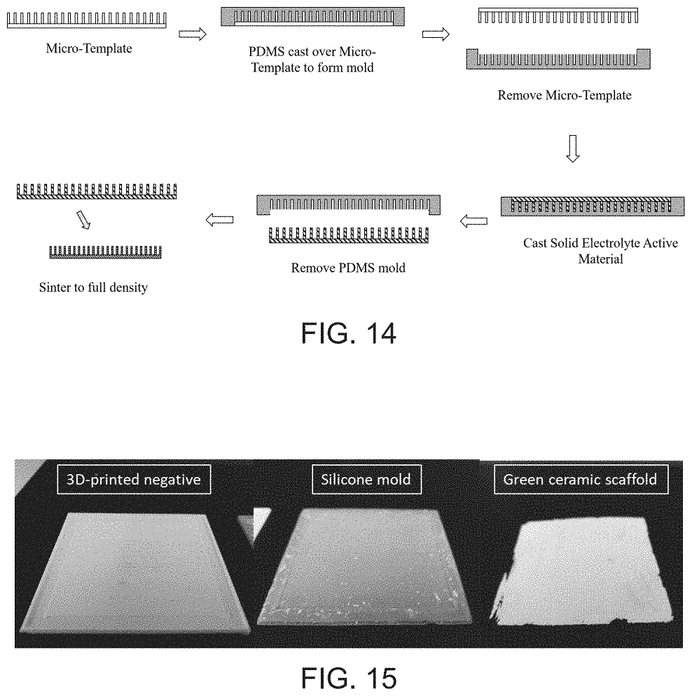

In one embodiment, a reusable net shape mold is fabricated out of silicone rubber and is subsequently infiltrated with ceramic slurry. The net shape mold is generated from a 3D printed negative which has the structure of the desired ceramic scaffold. This structure should have 75-95% porosity and ceramic feature thicknesses of less than 100 microns, allowing for facile removal of carbon species and uniform sintering. Examples of the 3D-printed negative, the silicone mold, and the resulting ceramic scaffold are shown schematically in FIG. 14 and demonstrated in FIG. 15.

FIG. 14 is a depiction of an example for net shape casting monolithic bilayers of solid-state electrolyte possessing both a porous scaffold and a dense ceramic separator. In this process a micro-template is 3D printed into the desired structure of the final green ceramic component. A polydimethylsiloxane (PDMS) cast is made over the microtemplate, cured and removed to form the mold. A ceramic slurry is then cast into the PDMS mold and allowed to form via solidification or solvent removal. Next the green ceramic component is removed from the mold and has the same morphology as the designed 3D printed micro template. Finally, the green ceramic component is sintered to full density.

FIG. 15 is an example of a c-LLZO green ceramic scaffold fabricated via net shape casting (right) and the components used to fabricate such a scaffold. In this embodiment, a 3D printed negative with the desired structure of the ceramic is produced (left). Then, the 3D printed negative is used to form a silicone mold (center). Finally, a slurry containing ceramic nanoparticles, a paraffin wax binder, a low melting polyethylene binder, and a dispersant is poured into the mold, allowed to solidify, and removed from the mold, resulting in the final structure.

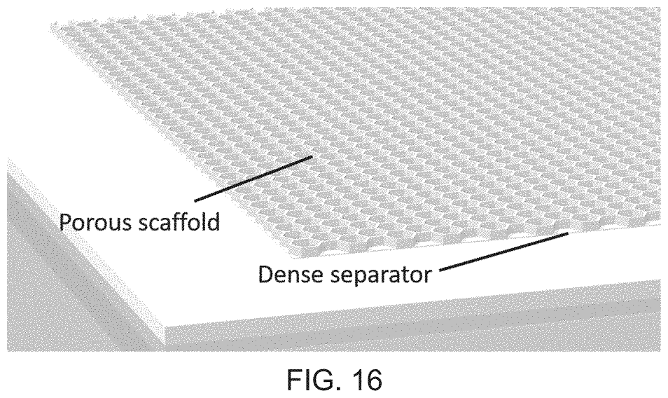

The structure can have a linear, honeycomb (depicted in FIG. 16), columnar, grid, or other pattern that allows for high porosity and mechanical strength. In this example the use of negative space in 3D printed parts can be used to enhance the resolution of the component. FIG. 16 is a 3D drawing of an exemplary 3D printed negative for a silicone mold intended for net shape casting of a ceramic bilayer architecture. The 3D printed negative has the shape of the intended ceramic architecture. The dimensions of the negative can be scaled arbitrarily in each direction to select ceramic feature and pore sizes and thicknesses, while maintaining a 90% porosity.

In another embodiment, a net shape mold is fabricated directly via 3D printing. The net shape mold can then be mechanically removed from the green ceramic scaffold. The structure of the ceramic scaffold should have 75-95% porosity and ceramic feature thicknesses as small as 25 microns, allowing for extremely facile removal of carbon species and uniform sintering. The structure can have a linear, honeycomb, columnar, grid, or other pattern that allows for high porosity and mechanical strength. Feature sizes this small are achieved by 3D printing the negative of the desired structure as opposed to the desired structure itself. Thus, the spatial resolution, NOT the nozzle or beam size, of the 3D printer controls the ultimate feature size of the ceramic.

In another embodiment, a reusable net shape mold is fabricated using a three-step process: 1) A 3D printed negative is fabricated. This structure is the negative of the desired ceramic scaffold. 2) a silicone rubber structure having the desired structure of the ceramic scaffold is formed by infiltrating the 3D printed negative with and subsequently curing a rubber/curing agent mixture. 3) A second silicone rubber negative is fabricated by infiltration/curing in the silicone rubber structure from step 2). The structure of the ceramic scaffold should have 75-95% porosity and ceramic feature thicknesses as small as 25 microns, allowing for extremely facile removal of carbon species and uniform sintering. Feature sizes this small are achieved by 3D printing the negative of the desired structure as opposed to the desired structure itself. Thus, the spatial resolution, NOT the nozzle or beam size, of the 3D printer controls the ultimate feature size of the ceramic. Using a silicone mold instead of a 3D printed mold allows easier green ceramic removal from the mold. The structure can have a linear, honeycomb, columnar, grid, or other pattern that allows for high porosity and mechanical strength.

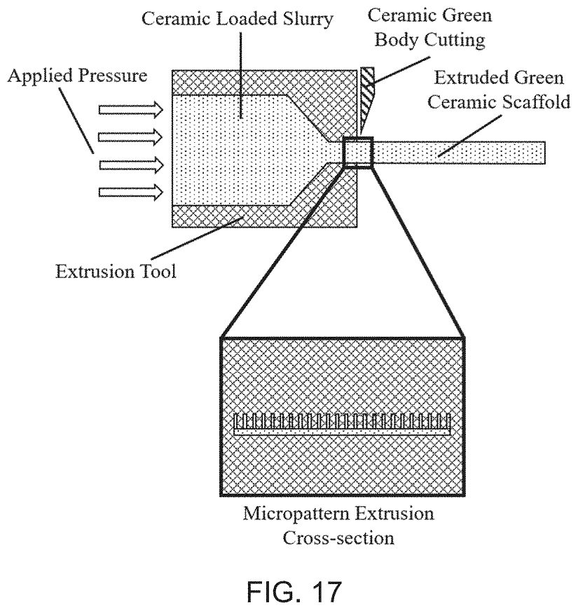

In another example, the 3D printed negative is etched with acetone or another plastic-dissolving solvent in order to increase the porosity of the 3D negative. In one example, a solid electrolyte architecture is composed of a microscopically ordered solid-state ion conducting ceramic is fabricated by adding a ceramic slurry to an extrusion apparatus that contains a slurry feeder system, and a screw to pump the slurry out a die with desired pore morphology, as depicted schematically in FIG. 17, which is a depiction of the process by which a microstructured green ceramic scaffold is fabricated using an extrusion process. A ceramic slurry is placed in the hopper of the extrusion tool and continuously passed through a patterned die of the cross section of the desired microstructure. The pattern shapes the slurry into the desired structure and the resulting tape can be cut to the desired planar dimensions.

In one example the binder in the green ceramic scaffold can be completely or partially removed by solvent extraction. Partially extracting binder can improve the efficiency of thermal debinding while still maintaining the structure with residual binder. As one example paraffin wax binder can be removed by treatment with xylene solvent.

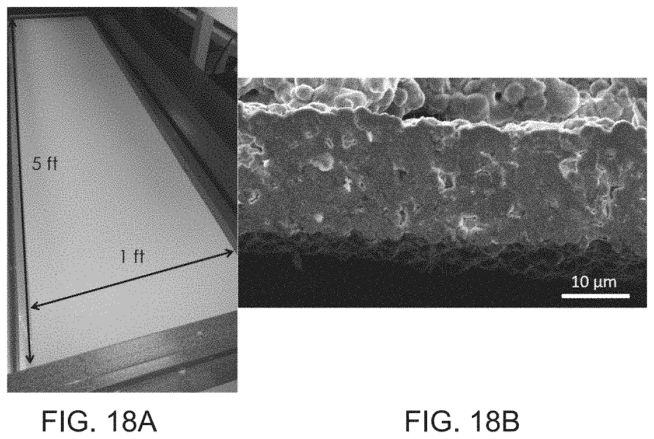

In certain embodiments, the solid-state electrolyte scaffold is attached to a ceramic separator that is less than 50 μm and as this as 5 μm and is greater than 95% dense, as shown in FIGS. 18A and 18B.

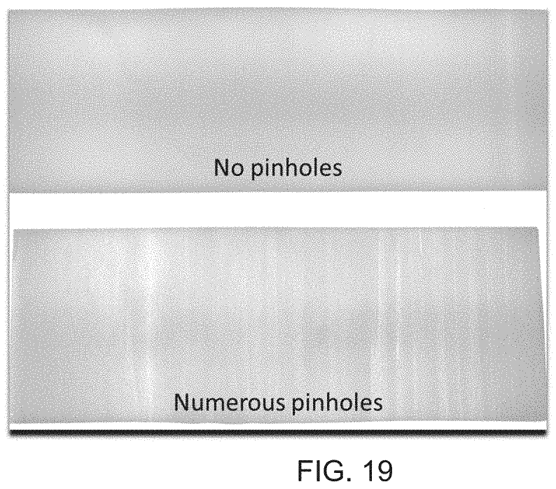

Per another example, both the porous scaffold and the dense separator are primarily composed of c-LLZO. Per another example, the dense separator is fabricated such that it is less than 50 μm thick and is free of pinholes and defects as shown in FIG. 19, which is photograph of a c-LLZO ceramic separator that is free of continuous pinholes (top) with a photograph of a ceramic separator containing pinholes (bottom) for comparison. The pinhole-free ceramic separator is less than 50 microns thick in its green state, less than 25 microns thick when sintered, and cast from a water-based slurry.

In one feature, defects due to differential shrinkage rates in multi-layer and multi-porosity ceramic pieces and be rendered uninfluential by the lamination of multiple green ceramic pieces.

In one feature of this disclosure, a dense solid state ceramic separator is attached to the porous scaffold to separate the anodic and cathodic components of a cell; in this feature, the solid state ceramic separator reduce or eliminates the need for a liquid electrolyte typically introduced to wet plastic separators in traditional lithium ion cells.

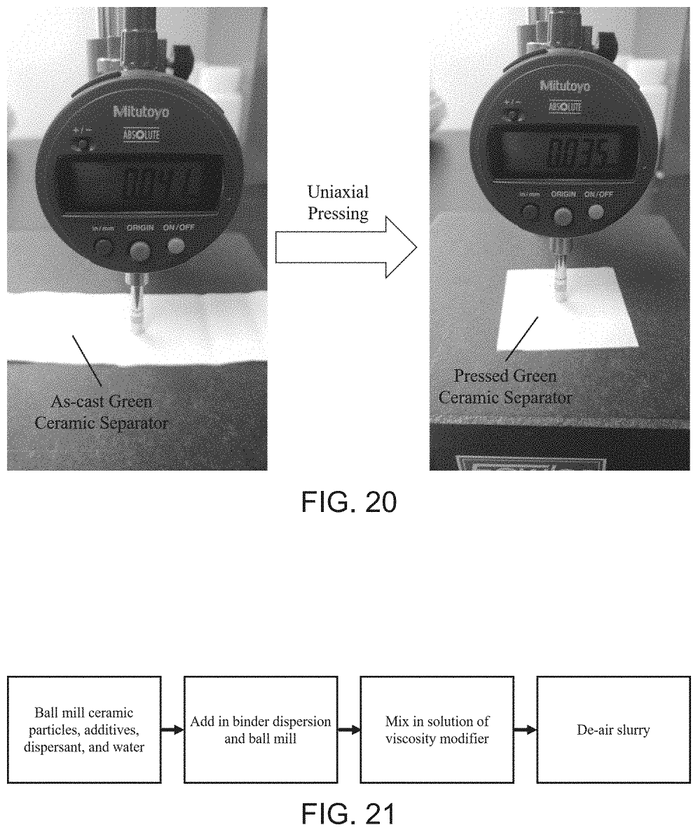

In one embodiment, an as cast green dense ceramic separator from can be further densified, in the green state, by uniaxially pressing with a hydraulic press at pressures from 1000 psi to 10000 psi, as demonstrated in FIG. 20.

In another feature, uniaxially pressing to increase the green density of a ceramic separator is done at elevated temperatures, in this feature, the temperature is one near or above the glass transition temperature of the polymeric binder in the green ceramic component; temperatures are generally selected from 25° C. to 120° C.

In an embodiment of this disclosure, green ceramic components are fabricated from slurries of ceramic nanoparticles, selected from the range of 25 nm to 1000 nm, polymeric binders, a dispersant, a plasticizer, a viscosity modifier, and a solvent.

In an embodiment of this disclosure, green ceramic components are fabricated from slurries of ceramic nanoparticles wherein the solvent component comprises mixtures and combinations of water, methanol, ethanol, propanol, butanol, xylene, hexane, methyl ethyl ketone, acetone, toluene, water, camphene, tert-butylalcohol, acetic acid, benzoic acid, camphene, cyclohexane, dioxane, dimethylsulfoxide, dimethylformamide, ethylene glycol, ionic liquids, glycerine ether, hydrogen peroxide, naphthalene, or a combination thereof.

In an embodiment of this disclosure, green ceramic components are fabricated from slurries of ceramic nanoparticles wherein the slurry comprises mixtures and combinations of dispersants selected but not limited to the group consisting of but not limited to poloxamers, fluorocarbons, alkylphenol ethoxylates, polyglycerol alkyl ethers, glucosal dialkylethers, crownethers, polyoxyethylene alkyl ethers, Brij, sorbitan esters, Tweens, polyacrylic acid, bicine, citric acid, steric acid, fish oil, phenylphosphonic acid, sulphates, sulfinates, phosphoric acid, ammonium polymethacrylate, alkyl ammoniums, phosphate esters, ionic liquids, molten salts, glycols, polyacrylates, amphiphilic molecules, organosilanes, and combinations thereof.

In an embodiment of this disclosure, green ceramic components are fabricated from slurries of ceramic nanoparticles wherein the slurry comprises a binder selected from the group consisting of polyvinyl butyral, aromatic compounds, acrylics, acrylates, fluorinated polymers, styrene-butadiene rubber, hydrocarbon chain polymers, silicones, polyvinyl acetate, polytetrafluoroethylene, acrylonitrile butadiene styrene, methyl cellulose, ethyl cellulose, carboxymethyl cellulose, polyacrylate esters, polyurethane, polyethylene glycol, acrylic compounds, polystyrene, polyvinyl alcohol, polymethylmethacrylate, polybutylmethacrylate, polyvinylfluoride, polyethylene oxide, poly(2-ethyl-2-oxazoline), and combinations thereof.

In an embodiment of this disclosure, green ceramic components are fabricated from slurries of ceramic nanoparticles wherein the slurry comprises a thickener selected from the group consisting of Xanthan gum, cellulose, carboxymethylcellulose, tapioca, alginate, chia seeds, guar gum, gelatin, cellulose, carrageenan, polysaccharides, galactomannan, glycols, acrylate cross polymer, and other plant-derived polymers.

In one embodiment, the slurry comprises a plasticizer selected from the group consisting of benzyl butyl phthalate, acetic acid alkyl esters, bis[2-(2-butoxyethoxy)ethyl] adipate, 1,2-Dibromo-4,5-bis(octyloxy)benzene, dibutyl adipate, dibutyl itaconate, dibutyl sebacate, dicyclohexyl phthalate, diethyl adipate, diethyl azelate, di(ethylene glycol) dibenzoiate, diethyl sebacate, diethyl succinate, diheptyl phthalate, diisobutyl adipate, diisobutyl fumarate, diisobutyl phthalate, diisodecyl adipate, diisononyl phthalate, dimethyl adipate, dimethyl azelate, dimethyl phthalate, dimethyl sebacate, dioctyl terephthalate, diphenyl phthalate, di(propylene glycol) dibenzoate, dipropyl phthalate, ethyl 4-acetylbutyrate, 2-(2-ethylhexyloxy)ethanol, isodecyl benzoate, isooctyl tallate, neopentyl glycol dimethylsulfate, 2-nitrophenyl octyl ether, poly(ethylene glycol) bis(2-ethylhexanoate), poly(ethylene glycol) dibenzoate, poly(ethylene glycol) dioleate, poly(ethylene glycol) monolaurate, poly(ethylene glycol) monooleate, poly(ethylene glycol) monooleate, sucrose benzoate, 2,2,4-trimethyl-1,3-pentanediol dibenzoate, trioctyl timelitate, and combinations thereof.

In one embodiment, a slurry of ceramic particles that contains water as the primary solvent is formulated containing any or all the following aforementioned dispersant, secondary solid materials, polymeric binder thickener, defoamer. By adjusting the loading of the primary ceramic, the slurry can be cast into green structures that, upon sintering, either have the properties of the dense ceramic or the porous scaffold, as depicted schematically in FIG. 21.

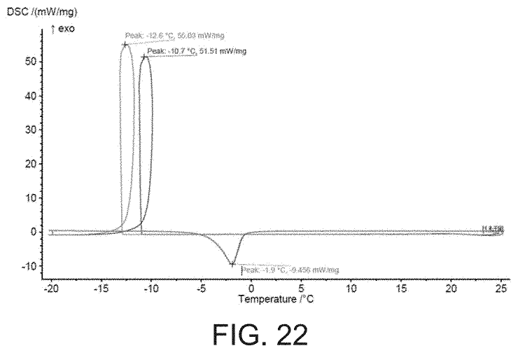

In another example, the freezing and melting points of the water-based ceramic slurries are determined using differential scanning calorimetry to determine optimal freeze tape casting parameters and shown in FIG. 22.

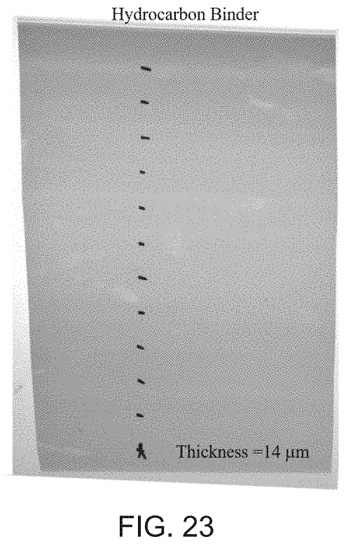

In one embodiment, the ceramic slurry used in the preparation of the microscopically ordered solid state electrolyte scaffold possess a polymeric binding agent that is comprised primarily or entirely of carbon and hydron, as shown in FIG. 23; in such as example, the solvent/dispersing phases may be an aromatic hydrocarbon for example toluene and or xylene.

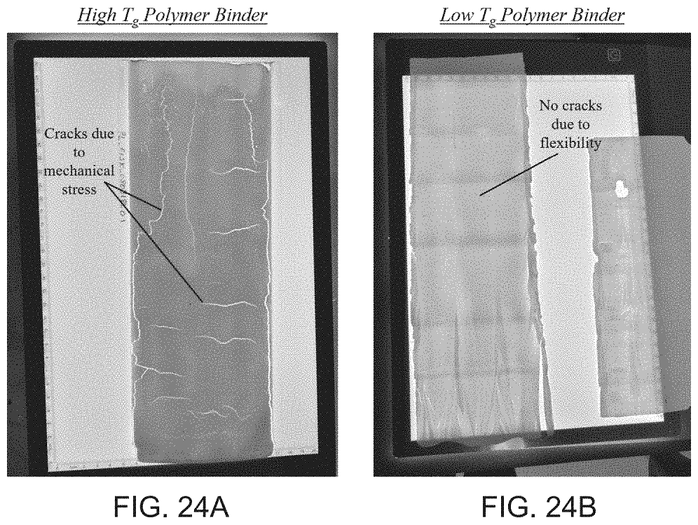

In one example, a solid electrolyte architecture is composed of a microscopically ordered solid-state ion conducting ceramic is fabricated by using a ceramic slurry which contains a polymeric binder, which may be an acrylic copolymer aqueous dispersion, with a glass transition temperature near or lower than the freeze casting surface; enabling segmental motion of the polymer and thus mechanical stability during the freeze processing, as shown in FIGS. 24A and 24B, which is a depiction of two green porous ceramic electrolyte scaffolds made via freeze tape casting using two different acrylic copolymer binders. The green component fabricated with a high glass transition temperature binder showed multiple cracks due to mechanical stresses. FIG. 24A. The component fabricated with a low glass transition temperature, near or below the casting temperature, demonstrates flexibility and does not display any cracking. FIG. 24B

In one embodiment, the ceramic slurry used in the preparation of the microscopically ordered solid state electrolyte scaffold possess an acrylic polymer or co-polymer dispersion as a binding agent in the green component.

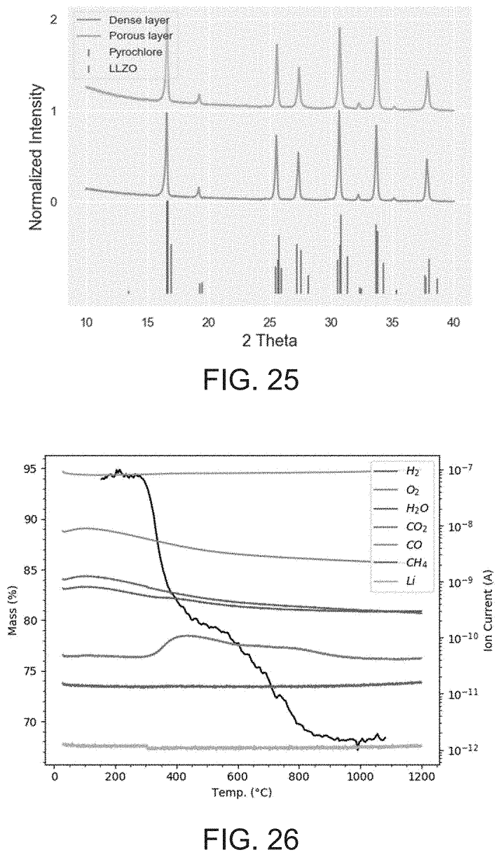

In one embodiment, c-LLZO is used as the primary ceramic. A slurry is formed using any of the processes described in this disclosure and Li2CO3 is added as a secondary solid. Upon sintering, the cubic structure of LLZO is maintained due to compensating lithium from the secondary solid species, as demonstrated in FIG. 25, which is an X-ray diffraction (XRD) of both the porous scaffold component and the dense separator component of a co-sintered LLZO bilayer. The spectra show that both components are phase pure (>98%) cubic LLZO which is necessary for high ionic conductivity and electrochemical performance. Phase purity is achieved in part by fabricating components using slurries possessing Li2CO3 additives, in the range of 1%-30% of the active material, that compensate for materials loss during sintering.

In one embodiment, an aqueous ceramic slurry is comprised of LLZO nanoparticles, a dispersant, an acrylic binder, and Li2CO3 powder (16% wt. to LLZO) to act as a sacrificial lithium source to compensate for material loss during heat treatment/sintering, as shown in FIG. 26.

In one embodiment, a non-aqueous ceramic slurry is comprised of LLZO nanoparticles, a dispersant, a hydrocarbon binder, and Li₂CO₃ powder (16% wt. to LLZO) to act as a sacrificial lithium source to compensate for material loss during heat treatment/sintering.

In one embodiment, a ceramic slurry possesses additives, in the range of 1%-30% of the ceramic, that decompose into oxidizing species to aid in organic content removal. One exemplary example of such an additive is LiNO₃ wherein the NO₃-decomposes to oxidizing species for organic removal, and the residual lithium can behave as an additional sacrificial lithium source to compensate for material loss during heating/sintering.

In one embodiment, a ceramic slurry possesses additives, in the range of 1%-30% of the ceramic, that decompose into oxidizing species to aid in organic content removal and additionally thicken the slurry, eliminating the need for additional thickening agents. One exemplary example of such an additive is LiC₂H₃O₂ wherein the dissolved LiC₂H₃O₂ thickens the slurry and the C₂H₃O₂— decomposes to oxidizing species for organic removal, and the residual lithium can behave as an additional sacrificial lithium source to compensate for material loss during heating/sintering.

In one embodiment, a slurry of ceramic particles and paraffin wax is formulated with any or all of the following: a long-chain carboxylic acid dispersant, a polyethylene binder with a melting point at or below that of the paraffin wax, and a secondary solid material including, but not limited to, Li₂CO₃. The slurry is solid at room temperature but liquid at moderately elevated temperatures (˜60° C.) and can be poured into net shape molds or run through net shape extrusion tools. The cooled and solidified green casts, shown in FIG. 15, can be heated at high temperatures to remove carbon species and sinter the ceramic particles.

In one embodiment, two or more green ceramic structures are fabricated using methods described in this patent. These green ceramic structures are placed in a hydraulic press and laminated together such that they are continuous and defect-free.

In one embodiment, two or more green ceramic structures are fabricated using methods described previously. These green ceramic structures are placed in an isostatic press and laminated together such that they are continuous and defect-free.

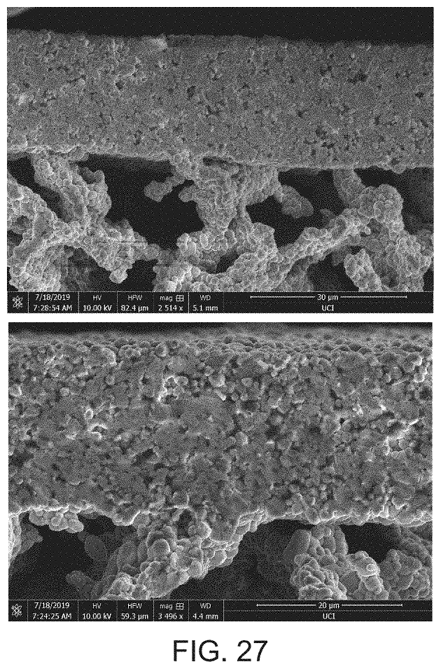

In one embodiment, two or more ceramics structures are fabricated using any methods described in this disclosure. The structures are stacked and loaded into a tube furnace and are sintered such that uniform, continuous co-sintering is achieved. In one embodiment, a green ceramic structure of porosity 75-95% is fabricated using methods described previously and a green ceramic structure of porosity >95% is fabricated using methods described previously. The two structures are stacked and sintered such that uniform, continuous co-sintering is achieved. The resulting co-sintered bilayer has a dense layer of >95% porosity and a porous layer of >80% porosity, as shown in FIG. 27, which is an SEM micrographs of ceramic ion-conducting bilayer architectures in which a porous c-LLZO scaffold with >75% porosity is connected to a dense c-LLZO separator with >95% density. The layers are stacked such that physical stacking is the only force required to create continuously sintered contacts between the constituent components.

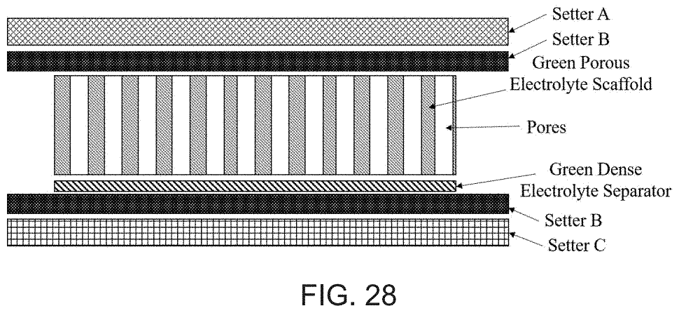

In another embodiment, the sintering and/or co-sintering of green ceramic components is carried out in an architecture that contains more than two types of setters to impart different functionality to different components during the debinding and sintering processes, as depicted schematically in FIG. 28. Setters may be made from ceramic, glass, metal, and carbonaceous materials. FIG. 28 is a depiction of an exemplary example of a stack used in the sintering of porous ceramic electrolyte scaffolds with dense ceramic separators in a bilayer architecture. In this example, the green porous scaffold is placed on top of the green ceramic separator without the need of any lamination or pressing. In this example three different setter types (A, B, and C) are incorporated for different physical and chemical properties to obtain the desired sintered component.

In one embodiment, the optimal temperature and dwell time for debinding of any green ceramic structure is determined by thermogravimetric analysis and mass spectrometry as shown in FIG. 26.

Although an exemplary embodiment of the present disclosure has been described and illustrated, it will be apparent to those skilled in the art that numerous modifications and variations can be made thereto without departing from the scope of the disclosure as defined in the appended claims.

The following examples describe various embodiments of the methods of the invention.

### Example 1

In one embodiment of the present invention, the microscopically ordered solid electrolyte architecture is comprised of c-LLZO that is formed by freeze tape casting and subsequently sintering a slurry comprising water, c-LLZO nanoparticles of particle size 400 nm, and several additives as described below.

First, a mixture of 35 g LLZO, 2.3% Li₂CO₃ sintering additive by weight, 43.5% water by weight, 0.7% Evonik SURFYNOL® CT-324 dispersant by weight, and 50% ZrO₂/Y₂O₃ milling media by volume was ball milled in a 250 mL jar for 16 hours.

Next, 4% acrylic co-polymer emulsion binder by weight was added to the mixture and the mixture was subsequently ball milled for 4 hours.

Next, a 1.25% by weight xanthan gum solution in water was prepared and added to the mixture 32.6% by weight. 0.4% Evonik SURFYNOL® DF-37 defoamer by weight was added and the mixture was mixed using an impeller, then on a ball mill with the milling media removed.

Next, the mixture was de-aired 5 times in a vacuum chamber to produce the slurry to be used in casting.

Next, the slurry was freeze tape cast to produce a porous green ceramic tape. In this process, slurry was poured into a hopper above a silicone-coated biaxially-oriented polyethylene terephthalate (boPET) carrier film. Then, the carrier film was moved across a flat casting surface and the slurry was drawn through a doctor blade at a set gap height of 1.0 mm. The doctor blade cast slurry was then moved over a freezing bed which induces a temperature gradient through the thickness of the cast slurry, set to a temperature of −18° C. such that the glass transition temperature of the binder was lower than the bed temperature.

Next, the frozen solvent was removed via sublimation by placing the cast slurry in a freeze dryer at −40° C. and 0.08 torr. The resulting structure was a green porous LLZO tape. This tape can be stacked on other green c-LLZO structures to form multilayer architectures. The green porous c-LLZO tape can be sintered to form a microscopically ordered scaffold with pore size ranging from 10 to 40 μm. The sintered c-LLZO, which has a cubic garnet structure, has Li ionic conductivity close to 0.1 S/m and thus can act as a primary electrolyte. The structure was porous enough that when fully infiltrated with active material, it can be used as a battery electrode that enables energy densities greater than 300 Wh/kg. The structure was vertically aligned such that active material slurry can easily infiltrate the pores and deposit active material.

### Example 2

In one embodiment of the present invention, the microscopically ordered solid electrolyte architecture was comprised of c-LLZO that was formed by freeze tape casting and subsequently sintering a slurry consisting of water, c-LLZO nanoparticles of particle size 400 nm, and several additives as described below.

First, a mixture of 35 g LLZO, 2.3% Li₂CO₃ sintering additive by weight, 43.5% water by weight, 0.7% Dow ECOSURF™ EH-9 dispersant by weight, and 50% ZrO₂/Y₂O₃ milling media by volume was ball milled in a 250 mL jar for 16 hours.

Next, 4% Dow RHOPLEX™ HA-12 acrylic co-polymer emulsion binder by weight was added to the mixture and the mixture was subsequently ball milled for 4 hours.

Next, a 1.25 weight % xanthan gum solution in water was prepared and added to the mixture 32.6% by weight. 0.4% SURFYNOL® DF-37 defoamer by weight was added and the mixture was mixed using and impeller, then a ball mill with the milling media removed.

Next, the mixture was de-aired 5 times in a vacuum chamber to produce the slurry to be used in casting.

Next, the slurry was freeze tape cast to produce a porous green ceramic tape. In this process, slurry was poured into a hopper above a silicone-coated boPET carrier film. Then, the carrier film was moved across a flat casting surface and the slurry was drawn through a doctor blade at a set gap height of 0.5 mm. The doctor blade cast slurry was then moved over a freezing bed which induces a temperature gradient through the thickness of the cast slurry, set to a temperature of −20° C. such that the glass transition temperature of the binder was lower than the bed temperature.

Next, the frozen solvent was removed via sublimation by placing the cast slurry in a freeze dryer at −40° C. and 0.08 torr. The resulting structure was a green porous LLZO tape. This tape can be stacked on other green c-LLZO structures to form multilayer architectures. The green porous c-LLZO tape can be sintered to form a microscopically ordered scaffold with pore size ranging from 10 to 40 μm. The sintered c-LLZO, which has a cubic garnet structure, has Li ionic conductivity close to 0.1 S/m and thus can act as a primary electrolyte. The structure was porous enough that when fully infiltrated with active material, it can be used as a battery electrode that enables energy densities greater than 300 Wh/kg. The structure was vertically aligned such that active material slurry can easily infiltrate the pores and deposit active material.

### Example 3

In one embodiment of the present invention, the microscopically ordered solid electrolyte architecture was comprised of c-LLZO that was formed by tape casting and subsequently sintering a slurry consisting of water, c-LLZO nanoparticles of particle size 400 nm, and several additives as described below.

First, a mixture of 10.19 g LLZO, 5.4% Li₂CO₃ sintering additive by weight, 3.41% benzyl butyl phthalate plasticizer, 24.14% ethanol, 23.57% acetone are ball milled for 16 hours at 114 rpm using 96 g of ZrO₂/Y₂O₃ milling media. Then 3.41% by weight polyvinyl butyral (Butvar B-98) binder was added to the slurry and ball milled for an additional 4 hours.

Next, the slurry was tape cast to produce a dense green ceramic tape. In this process, the mixture was poured into a hopper above a silicone-coated boPET carrier film. Then, the slurry was drawn through a doctor blade at a set gap height of 0.05 mm at 1 m/min onto the carrier film which was moved across a flat casting surface at Zone 1: 40° C., 2: 55° C., 3: 60° C., 4: 70° C., 5: 75° C. The resulting structure was a green dense c-LLZO tape. This tape can be stacked on other green c-LLZO structures to form multilayer architectures. The green dense c-LLZO tape can be sintered to form an ionically conductive separator that was free of continuous pinholes, less than 25 μm thick, and at least 95% dense.

### Example 4

In one embodiment of the present invention, the microscopically ordered solid electrolyte architecture was comprised of c-LLZO that was formed by tape casting and subsequently sintering a slurry consisting of water, c-LLZO nanoparticles of particle size 400 nm, and several additives as described below.

First, a mixture of 29.96 g LLZO, 4.04% Li₂CO₃ sintering additive by weight, 0.25% phosphate ester dispersant, and 34.40% xylene milled for 16 hours at 92 rpm using 96 g of ZrO₂/Y₂O₃ milling media. Then 34.40% by weight hydrocarbon binder was added to the slurry and ball milled for an additional 4 hours.

Next, the slurry was tape cast to produce a dense green ceramic tape. In this process, the mixture was poured into a hopper above a silicone-coated boPET carrier film. Then, the slurry was drawn through a doctor blade at a set gap height of 0.05 mm at 1 m/min onto the carrier film which was moved across a flat casting surface at Zone 1: 40° C., 2: 55° C., 3: 60° C., 4: 70° C., 5: 75° C. The resulting structure was a green dense c-LLZO tape. This tape can be stacked on other green c-LLZO structures to form multilayer architectures. The green dense c-LLZO tape can be sintered to form an ionically conductive separator that was free of continuous pinholes, less than 25 μm thick, and at least 95% dense.

### Example 5

In one embodiment of the present invention, the microscopically ordered solid electrolyte architecture was comprised of c-LLZO that was formed by tape casting and subsequently sintering a slurry consisting of water, c-LLZO nanoparticles of particle size 400 nm, and several additives as described below.

First, a mixture of 30.39 g LLZO, 2.67% LiOH sintering additive by weight, 0.25% phosphate ester dispersant, and 34.89% xylene milled for 16 hours at 92 rpm using 96 g of ZrO₂/Y₂O₃ milling media. Then 31.80% by weight hydrocarbon binder was added to the slurry and ball milled for an additional 4 hours.

Next, the slurry was tape cast to produce a dense green ceramic tape. In this process, the mixture was poured into a hopper above a silicone-coated boPET carrier film. Then, the slurry was drawn through a doctor blade at a set gap height of 0.05 mm at 1 m/min onto the carrier film which was moved across a flat casting surface at Zone 1: 40° C., 2: 55° C., 3: 60° C., 4: 70° C., 5: 75° C. The resulting structure was a green dense c-LLZO tape. This tape can be stacked on other green c-LLZO structures to form multilayer architectures. The green dense c-LLZO tape can be sintered to form an ionically conductive separator that was free of continuous pinholes, less than 25 μm thick, and at least 95% dense.

### Example 6

In one embodiment of the present invention, the microscopically ordered solid electrolyte architecture was comprised of c-LLZO that was formed by tape casting and subsequently sintering a slurry consisting of water, c-LLZO nanoparticles of particle size 400 nm, and several additives as described below.

First, a mixture of 30.70 g LLZO, 1.66% Li₂O sintering additive by weight, 0.25% phosphate ester dispersant, and 34.89% xylene milled for 16 hours at 92 rpm using 96 g of ZrO₂/Y₂O₃ milling media. Then 35.26% by weight hydrocarbon binder was added to the slurry and ball milled for an additional 4 hours.

Next, the slurry was tape cast to produce a dense green ceramic tape. In this process, the mixture was poured into a hopper above a silicone-coated boPET carrier film. Then, the slurry was drawn through a doctor blade at a set gap height of 0.05 mm at 1 m/min onto the carrier film which was moved across a flat casting surface at Zone 1: 40° C., 2: 55° C., 3: 60° C., 4: 70° C., 5: 75° C. The resulting structure was a green dense c-LLZO tape. This tape can be stacked on other green c-LLZO structures to form multilayer architectures. The green dense c-LLZO tape can be sintered to form an ionically conductive separator that was free of continuous pinholes, less than 25 μm thick, and at least 95% dense.

### Example 7

In another embodiment, a thin, dense, ionically conductive separator comprised of c-LLZO was formed by tape casting and subsequently sintering a slurry consisting of water, c-LLZO nanoparticles of particle size 400 nm, and several additives as described below.

First, a mixture of 40 g LLZO, 54% water by weight, 1.3% dispersant by weight, 4.5% Li₂O₃ sintering additive by weight, and 500 g ZrO₂/Y₂O₃ milling media was ball milled for 16 hours.

Next, 7.8% acrylic co-polymer emulsion binder by weight was added to the mixture and the mixture was ball milled for 4 hours.

Next, 0.4% SURFYNOL® DF-37 defoamer was added as needed and mixed into the mixture.

Next, the mixture was de-aired in a vacuum chamber 5 times to produce the slurry to be used in casting.

Next, the slurry was tape cast to produce a dense green ceramic tape. In this process, the mixture was poured into a hopper above a silicone-coated boPET carrier film. Then, the slurry was drawn through a doctor blade at a set gap height of 0.13 mm onto the carrier film which was moved across a flat casting surface at 80° C. The resulting structure was a green dense c-LLZO tape. This tape can be stacked on other green c-LLZO structures to form multilayer architectures. The green dense c-LLZO tape can be sintered to form an ionically conductive separator that was free of continuous pinholes, less than 25 μm thick, and at least 95% dense.

### Example 8

In another embodiment, a thin, dense, ionically conductive separator comprised of c-LLZO was formed by tape casting and subsequently sintering a slurry consisting of water, c-LLZO nanoparticles of particle size 400 nm, and several additives as described below.

First, a mixture of 40 g LLZO, 54% water by weight, 1.3% dispersant by weight, 4.5% Li₂NO₃ sintering additive by weight, and 500 g ZrO₂/Y₂O₃ milling media was ball milled for 16 hours.

Next, 7.8% acrylic co-polymer emulsion binder by weight was added to the mixture and the mixture was ball milled for 4 hours.

Next, 0.4% SURFYNOL® DF-37 defoamer was added as needed and mixed into the mixture.

Next, the mixture was de-aired in a vacuum chamber 5 times to produce the slurry to be used in casting.

Next, the slurry was tape cast to produce a dense green ceramic tape. In this process, the mixture was poured into a hopper above a silicone-coated boPET carrier film. Then, slurry was drawn through a doctor blade at a set gap height of 0.13 mm onto the carrier film which was moved across a flat casting surface at 80° C. The resulting structure was a green dense c-LLZO tape. This tape can be stacked on other green c-LLZO structures to form multilayer architectures. The green dense c-LLZO tape can be sintered to form an ionically conductive separator that was free of continuous pinholes, less than 25 μm thick, and at least 95% dense.

### Example 9

In another embodiment of the invention, a porous green c-LLZO tape was stacked on a dense green c-LLZO tape. The stack was placed on a smooth graphite substrate which rests on a dense alumina substrate. A smooth graphite superstrate was placed on top of the stack. A porous alumina superstrate was placed on top of the graphite superstrate. The entire stack was placed in a furnace and sintered as describe below.

First, the temperature was set to 150° C. to remove water. Then the temperature was set to 400° C. to remove organic species. Then the temperature was set to 900° C. to remove carbonate species. Then argon gas was flowed into the furnace and the temperature was set to 1090° C. to sinter the gains of the ceramic structures. The furnace was then allowed to cool to room temperature.

The resulting sintered ceramic scaffold consists of a dense separator and a porous scaffold. The two layers are continuously co-sintered together; the mechanical stacking of the substrates, layers, and superstrates was the only force required to result in successful co-sintering. The graphite sub- and superstrates allow the ceramic layers to contract without cracking. The porous alumina superstrate was porous enough to allow removal of organic species. The porous alumina superstrate was the correct weight to maintain flatness of the sintered bilayer without crushing the porous structure. The Li₂CO₃ additive in the ceramic slurries prevents the loss of Li in the c-LLZO structure. Both layers in the structure are phase pure c-LLZO. The presence of the porous layer traps gas and prevents Li loss in the dense layer, allowing it to maintain phase purity.

### Example 10

In another embodiment of the invention, a silicone net shape mold was fabricated from a 3D printed template as describe below.

First, a fused deposition melting (FDM) 3D printer with a nozzle size of 0.4 mm was used to print a 3D template structure out of polylactic acid (PLA) resin. The template structure has the structure of the desired green ceramic structure. It consists of a continuous 5 cm wide x 5 cm long x 50 μm thick dense layer and a 600 μm thick porous layer. The structure of the porous layer was a periodic array of 100 μm wide x 5 cm long walls with 400 μm separation.

Next, the template structure was sprayed with silicone mold release. Then, Firm 128 silicone rubber formula and catalyst are poured over the template in a 10:1 ratio. The rubber was allowed to cure and the 3D template was removed from the resulting silicone mold.

The reusable silicone mold was filled with ceramic slurries to create monolithic green ceramic multilayer structures. The dense layer portion of the structure has the properties of the dense separator described in Example 2 when sintered, and the porous layer portion of the structure has the properties of the porous scaffold described in Example 1 when sintered.

### Example 11

In another embodiment of the invention, the microscopically ordered solid electrolyte architecture was comprised of c-LLZO that was formed by net shape casting and subsequently sintering a slurry consisting of paraffin wax, c-LLZO nanoparticles, and several additives as described below.

First, 36% c-LLZO nanoparticles of particle size 400 nm by weight, 6% Li₂CO₃ by weight, 1% polyethylene by weight, 0.5% oleic acid by weight, and 7% paraffin wax by weight are mixed together at a temperature slightly above the melting point of the paraffin wax, approximately 60° C.

Next, the silicone mold was filled with the paraffin-based slurry. The mold was lightly heated to maintain liquidity of the slurry. A steel roller was passed over the top of the mold in order to fully infiltrate the mold with slurry, to flatten the top of the structure, and to remove excess slurry. The slurry was then allowed to cool in the mold and the resulting monolithic green ceramic multilayer structure was subsequently peeled out of the mold.

The sintering profile described in preceding examples was used to sinter the structure. The resulting sintered multilayer structure has the properties described in the previous examples.

### Example 12

In one embodiment of the present invention, the microscopically ordered solid electrolyte architecture was comprised of c-LLZO that was formed by freeze tape casting and subsequently sintering a slurry consisting of water, c-LLZO nanoparticles of particle size 400 nm, and several additives as described below.

First, a mixture of 5 g LLZO, 0.98% Li₂CO₃ sintering additive by weight, 32.17% water by weight, 0.32% Evonik SURFYNOL® CT-324 dispersant by weight, and 50% ZrO₂/Y₂O₃ milling media by milling jar volume was ball milled for 16 hours in a 60 mL jar.

Next, 0.45% acrylic co-polymer emulsion binder by weight was added to the mixture and the mixture was subsequently ball milled for 4 hours.

Next, a thickener solution consisting of 2% DuPont WALOCEL™ CRT 2000 PA carboxymethyl cellulose (CMC) powder by weight in water, and a second thickener solution of 1% xanthan gum by weight in water were prepared. The thickeners solutions are added to the mixture in 53.90% CMC solution by weight and 4.86% xanthan gum solution by weight amounts. The mixture was mixed using an impeller, then a ball mill with the milling media removed.

Next, 0.20% Evonik DYNOL™ 604 surfactant by weight, and SURFYNOL DF-37 defoamer as needed are added and the mixture was stirred.

Next, the mixture was de-aired 5 times in a vacuum chamber to produce the slurry to be used in casting.

Next, the slurry was freeze tape cast to produce a porous green ceramic tape and subsequently the frozen solvent was removed via sublimation by placing the cast slurry in a freeze dryer at −40° C. and 0.08 torr. The resulting structure was a green porous LLZO tape. The dried tape is then sintered as described in Example 1, resulting in a sintered porous ceramic c-LLZO scaffold with properties similar as those described in Example 1, with pores 40-100 μm wide, allowing for infiltration of large active material particles.

### Example 13

In another embodiment of this invention, a polyethylene terephthalate net shape mold was prepared as described in Example 5. A water-based ceramic slurry was prepared as described in Example 2. The slurry was freeze cast in the bed as described below.

After preparing the mold and slurry, the mold was placed on a frozen bed at temperature −22° C. The slurry was poured into the mold and allowed to solidify.

Next, the frozen solvent was removed via sublimation by placing the demolded frozen slurry cast in a freeze dryer. The resulting structure was a green monolithic bilayer LLZO tape. This tape can be sintered using the same sintering procedure described in Example 3. The resulting sintered ceramic scaffold has the same properties as the sintered ceramic scaffold described in Example 3.

### Example 14

In another embodiment of this invention, the green density of a green ceramic separator tape was increased by uniaxial pressing under elevated temperatures.

As one example, a 5.35 cm by 5.35 cm green dense film comprised of 75% by weight LLZO, 10% Li₂CO₃, 10% RayFlex 777 acrylic co-polymer binder, 3% Dow ECOSURF™ EH-9 dispersant, and 1% xanthan gum thickener was placed between silicone-coated boPET sheets and pressed, uniaxially, at 7000 psi at 145° C. for 5 mins. The green density increases by 11%.

### Example 15

In another embodiment of this invention, the green density of a green ceramic separator tape was increased, and continuous pinholes and other manufacturing defects are removed by uniaxial lamination under elevated temperatures.

As one example, two or more sheets of 5.35 cm by 5.35 cm green dense film comprised of 75% by weight LLZO, 10% Li₂CO₃, 10% RayFlex 777 acrylic co-polymer binder, 3% Dow ECOSURF™ EH-9 dispersant, and 1% xanthan gum thickener were placed between silicone-coated boPET sheets and pressed, uniaxially, at 7000 psi at 145° C. for 5 mins. The green density increases by 11%, and continuous defects and pinholes are removed by lamination.

### Example 16

In another embodiment of this invention, the green density of a green ceramic separator tape was increased, and continuous pinholes and other manufacturing defects are removed by isostatic lamination under elevated temperatures.

As one example, two or more sheets of 5.35 cm by 5.35 cm green dense film comprised of 77% by weight LLZO, 10% Li₂CO₃, 12% hydrocarbon binder, 1% phosphate ester dispersant, were placed between silicone-coated boPET sheets and vacuum sealed with a solid support in an aluminized boPET bag, and pressed, isostatically, at 6000 psi at 70° C. for 10 mins.

### Example 17

In one embodiment of the present invention, the microscopically ordered solid electrolyte architecture was comprised of c-LLZO that was formed by freeze tape casting and subsequently sintering a slurry consisting of water, c-LLZO nanoparticles of particle size 500 nm, and several additives as described below.

First, a mixture of 5 g LLZO, 0.83% Li₂CO₃ sintering additive by weight, 27.64% water by weight, 0.27% Evonik SURFYNOL® CT-324 dispersant by weight, and 50% ZrO₂/Y₂O₃ milling media by milling jar volume was ball milled for 16 hours in a 60 mL jar.

Next, 0.35% acrylic co-polymer emulsion binder by weight was added to the mixture and the mixture was subsequently ball milled for 2 hours.

Next, a thickener solution consisting of 2% DuPont WALOCEL™ CRT 2000 PA carboxymethyl cellulose (CMC) powder by weight in water, and a second thickener solution of 1% xanthan gum by weight in water were prepared. The thickeners solutions are added to the mixture in 55.59% CMC solution by weight and 9.24% xanthan gum solution by weight amounts. The mixture was mixed using an impeller, then a ball mill with the milling media removed.

Next, 0.07% Evonik DYNOL™ 604 surfactant by weight and SURFYNOL® DF-37 defoamer as needed are added and the mixture was stirred.

Next, the mixture was de-aired 5 times in a vacuum chamber to produce the slurry to be used in casting.

Next, the slurry was freeze tape cast at a carrier film advancement rate of 1.7 cm/min onto a freezing bed set to −15° C., followed by drying via sublimation by placing the cast slurry in a freeze dryer at −30° C. and 0.08 torr. The resulting structure was a green porous LLZO tape. The tape is subsequently sintered as described in Example 1, resulting in a sintered porous ceramic c-LLZO scaffold with similar properties as those described in Example 1, with pores 50-100 μm wide, allowing for easy infiltration of large active material particles.

### Example 18

In one embodiment of the present invention, the microscopically ordered solid electrolyte architecture was comprised of c-LLZO that was formed by freeze tape casting and subsequently sintering a slurry consisting of water, c-LLZO nanoparticles of particle size 500 nm, and several additives as described below.

First, a mixture of 5 g LLZO, 0.83% Li₂CO₃ sintering additive by weight, 27.64% water by weight, 0.27% Evonik SURFYNOL® CT-324 dispersant by weight, and 50% ZrO₂/Y₂O₃ milling media by milling jar volume was ball milled for 16 hours in a 60 mL jar.

Next, 0.35% acrylic co-polymer emulsion binder by weight was added to the mixture and the mixture was subsequently ball milled for 2 hours.

Next, a thickener solution consisting of 2% DuPont WALOCEL™ CRT 2000 PA carboxymethyl cellulose (CMC) powder by weight in water, and a second thickener solution of 1% xanthan gum by weight in water were prepared. The thickeners solutions are added to the mixture in 55.59% CMC solution by weight and 9.24% xanthan gum solution by weight amounts. The mixture was mixed using an impeller, then a ball mill with the milling media removed.

Next, 0.07% Evonik DYNOL™ 604 surfactant by weight and SURFYNOL® DF-37 defoamer as needed are added and the mixture was stirred.

Next, the mixture was de-aired 5 times in a vacuum chamber to produce the slurry to be used in casting.

Next, the slurry was freeze tape cast at a carrier film advancement rate of 1.7 cm/min, imposing a gradual decrease in slurry temperature until reaching the freezing bed set to −15° C., followed by drying via sublimation by placing the cast slurry in a freeze dryer at −30° C. and 0.08 torr. The resulting structure was a green porous LLZO tape. The tape is subsequently sintered as described in Example 1, resulting in a sintered porous ceramic c-LLZO scaffold with similar properties as those described in Example 1, with pores 50-100 μm wide, allowing for easy infiltration of large active material particles.

### Example 19

In one embodiment of the present invention, the microscopically ordered solid electrolyte architecture was comprised of c-LLZO that was formed by freeze tape casting and subsequently sintering a slurry consisting of water, c-LLZO nanoparticles of particle size 500 nm, and several additives as described below.

First, a mixture of 12 g LLZO, 3.38% Li₂CO₃ sintering additive by weight, 40.64% water by weight, 1.15% Evonik SURFYNOL® CT-324 dispersant by weight, and 50% ZrO₂/Y₂O₃ milling media by milling jar volume was ball milled for 16 hours in a 60 mL jar.

Next, 2.85% acrylic co-polymer emulsion binder by weight was added to the mixture and the mixture was subsequently ball milled for 2 hours.

Next, a thickener solution consisting of 3% DuPont WALOCEL™ CRT 2000 PA carboxymethyl cellulose (CMC) powder by weight in water was prepared. The thickener solution was added to the mixture in 26.96% solution by weight. The mixture was mixed using an impeller, then a ball mill with the milling media removed.

Next, 0.20% Evonik DYNOL™ 604 surfactant by weight, and SURFYNOL® DF-37 defoamer as needed are added and the mixture was stirred.

Next, the mixture was de-aired 5 times in a vacuum chamber to produce the slurry to be used in casting. Additional defoamer additions and de-airing steps are included as needed.

Next, the slurry was freeze tape cast at a carrier film advancement rate of 0.85 cm/min to produce a porous green ceramic tape and kept at −5° C. under atmospheric pressure for 72 hours.

Next, the frozen solvent was removed via sublimation by placing the cast slurry in a freeze dryer at −30° C. and 0.08 torr. The resulting structure was a green porous LLZO tape. The tape is subsequently sintered as described in Example 1, resulting in a sintered porous ceramic c-LLZO scaffold with similar properties as those described in Example 1, with pores >80 μm wide, allowing for easy infiltration of large active material particles.

We claim:

1. A microscopically ordered solid electrolyte architecture for solid-state and hybrid Li ion batteries, wherein said architecture comprises at least one porous scaffold comprising a lithium conducting ceramic having a porosity that enables it to be infiltrated with cathode and/or anode active material in an amount sufficient to enable energy densities greater than 300 Wh/kg.

2. The microscopically ordered solid electrolyte architecture of claim 1, which contains a scaffold comprised of a primary electrolyte that is a porous ion-conducting solid-state ceramic oxide material with pore size ranging from 20 μm to 1000 μm.

3. The microscopically ordered solid electrolyte architecture of claim 2, where the primary electrolyte scaffold is connected to a separator in a multilayered ceramic architecture, the separator comprising a solid-state ion conductor.

4. The microscopically ordered solid electrolyte architecture of claim 3, wherein the multilayer ceramic architecture comprises a monolithic structure of the porous ceramic scaffold and the ceramic separator.

5. The microscopically ordered solid electrolyte architecture of claim 3, wherein the separator is substantially free of continuous pinholes.

6. The microscopically ordered solid electrolyte architecture of claim 3, wherein the separator has a sintered thickness of 25 μm or less.

7. The microscopically ordered solid electrolyte architecture of claim 3, wherein the separator has a sintered density of at least 95%.

8. The microscopically ordered solid electrolyte architecture of claim 1, which has a cubic garnet-type structure.

9. The microscopically ordered solid electrolyte architecture of claim 8, wherein the cubic garnet-type structure is Li₇La₃Zr₂O₁₂.

10. A method of making a microscopically ordered solid electrolyte architecture, any preceding claims, for solid-state and hybrid Li ion batteries, the method comprising:
fabricating one or multiple green ceramic scaffolds;
When there are multiple green ceramic scaffolds, forming an interface between the multiple ceramic scaffolds by stacking, pressing, or chemical treatment; and
performing at least one thermal treatment step on the green ceramic scaffold(s).

11. The method of claim 10, wherein at least one of the green ceramic scaffolds is fabricated by casting a ceramic slurry onto a casting surface.

12. The method of claim 10, wherein the at least one thermal treatment step is sufficient to remove organic material in the green ceramic scaffolds, increase the density of the scaffolds, or both.

13. The method of claim 10, wherein the at least one thermal treatment step comprises sintering to form a sintered microscopically ordered solid electrolyte architecture.

14. The method of claim 13, wherein the sintered microscopically ordered solid electrolyte architecture has at least one layer with density of at least 95% and a thickness of 25 μm or less.

15. The method of claim 10, wherein at least one of the green ceramic scaffolds is fabricated by net shape casting.

16. The method of claim 15, wherein the net shape casting comprising filling a sacrificial or reusable net-shape mold with at least one ceramic slurry, the net-shaped mold is configured to define the form factor of ceramic component of controlled and uniform cross section and planar form.

17. The method of claim 16, wherein the net shape mold is sacrificial and is removed by solvent extraction, dissolution, or burn-out.

18. The method of claim 10, wherein at least one of the green ceramic scaffolds is fabricated by extrusion processing.

19. The method of claim 10, further comprising forming at least one green ceramic separator having a thickness of less than 50 μm, wherein said separator touches at least one of said green scaffolds.

20. The method of claim 19, further comprising forming a multilayer ceramic structure by layering at least one green separator that is a solid-state ion conductor, wherein the separator does not comprise plastic, and is connected to the scaffold to form a monolithic component.

21. The method of claim 19, wherein the separator is substantially free of continuous pinholes.

22. The method of claim 19, further comprising applying pressure to the green separator to increase the green density of the separator.

23. The method of claim 11, wherein the ceramic slurry comprises one or more solvents or dispersing agents.

24. The method of claim 23, wherein one or more solvents or dispersing agents comprises water.

25. The method of claim 11, wherein the ceramic slurry further comprises at least one compatible hydrocarbon binder.

26. The method of claim 25, wherein the slurry comprises at least one polymeric binder having a glass transition temperature near or below the temperature of the casting surface.

27. The method of claim 26, wherein the at least one polymeric binder comprises compatible dispersions of acrylic polymers and copolymers.

28. The method of claim 11, wherein the ceramic slurry comprises additives, in an amount ranging from 1% to 30% of the ceramic, that compensate for material loss during said thermal treatment step.

29. The method of claim 11, wherein at least one ceramic slurry possessing additives, in an amount ranging from 1% to 30% by weight of the ceramic, decompose into oxidizing species to aid in organic content removal.

30. The method of claims 15 and/or 18, further comprising melt infiltrating the net shape molds and/or melt extruding at least one ceramic slurry that comprises ceramic nanoparticles, a paraffin wax binder, a low melting polyethylene binder, and a dispersant.

31. The method of claim 10, further comprising using a co-sintered multi-layer ceramic composed of constituent ceramics with each layer having individual physical properties such that each layer has a unique function selected from the group chosen from blocking lithium dendrites; providing an ionically conducting pathway; providing an electronically insulating layer; providing a porous structure that can be infiltrated with active material; providing a mechanically robust scaffold; preventing delamination of active material; providing a scaffold into which metallic lithium can be melt or vapor deposited; providing an interface onto which lithium can be electrochemically deposited; being more than 95% dense; and being more than 90% porous.

32. The method of claim 31, further comprising laminating two or more green ceramic pieces and co-sintering said pieces at or below 1200° C.

33. The method of claim 31, wherein the combination of a porous green ceramic piece with a dense ceramic piece allows the dense piece to maintain phase purity during sintering.

34. The method of claim 31, wherein physical stacking is the only force required to create sintered contacts between the two or more green ceramic pieces.

35. The method of claim 31, wherein the stack architecture in the furnace contains two or more types of substrates and/or superstrates to impart different functions to different components during the sintering process, wherein the different functions are chosen from: providing a friction-free surface that allows a ceramic layer to contract without cracking; being porous enough to allow organic species removal, and being the correct weight to maintain flatness of the ceramic structures without crushing their microstructure.
